(19) United States
(12) Patent Application Publication
(10) Pub. No.: US 2023/0386722 A1
(43) Pub. Date: Nov. 30, 2023

(54) COIL COMPONENT

(71) Applicant: TAIYO YUDEN CO., LTD., Tokyo (JP)

(72) Inventors: Shinya AKIYAMA, Tokyo (JP); Noriyuki MABUCHI, Tokyo (JP)

(21) Appl. No.: 18/322,267

(22) Filed: May 23, 2023

(30) Foreign Application Priority Data
May 30, 2022 (JP) 2022-088102

(51) Int. Cl. H01F 17/00

(52) U.S. Cl. CPC H01F 17/0013; H01F 2017/002

(57) ABSTRACT

Provided is a coil component having improved characteristics obtained by improved lead-out portions. A coil component according to one embodiment includes: a base body made of a magnetic material and having a mounting surface; first and second external electrodes provided on the mounting surface; and a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode. The first lead-out portion includes a first top-side shaft portion, a first bottom-side shaft portion located closer to the coil axis than the first top-side shaft portion, and a first connection portion connecting between the first top-side shaft portion and the first bottom-side shaft portion.

### CROSS-REFERENCE TO RELATED APPLICATIONS

This application is based on and claims the benefit of priority from Japanese Patent Application Serial No. 2022-088102 (filed on May 30, 2022), the contents of which are hereby incorporated by reference in their entirety.

### TECHNICAL FIELD

The present disclosure relates mainly to a coil component.

### BACKGROUND

Coil components are passive elements used in electronic devices. For example, coil components are used to eliminate noise in power source lines or signal lines. Coil components are constituted by a base body made of a magnetic material, a coil conductor provided in the base body, and a pair of external electrodes connected to one end and the other end of the coil conductor. The coil conductor includes a winding portion extending along a circumferential direction around a coil axis, and lead-out portions that connect both ends of the winding portion to corresponding external electrodes.

One example of the conventional coil components is disclosed in Japanese Patent Application Publication No. 2011-009391 (“the '391 Publication”). In the coil component described in the '391 Publication, the lead-out portions extending in parallel with the coil axis connect between the winding portion and the external electrodes located on the bottom surface of the base body.

As disclosed in the '391 Publication, coil components are designed such that the winding portion has a large diameter in order to obtain a large inductance. When the external electrodes are located on the bottom surface of the base body, a larger diameter of the winding portion results in a smaller distance between the lead-out portions and the side surfaces or the end surfaces of the base body. Therefore, conventional coil components have a large magnetic resistance around the lead-out portions, and this large magnetic resistance around the lead-out portions deteriorates the magnetic characteristics of the coil components. In addition, magnetic saturation tends to occur in the narrow regions between the lead-out portions and the side surfaces or the end surfaces of the base body. Therefore, the small distance between the lead-out portions and the side surfaces or the end surfaces of the base body can also deteriorate the DC superposition characteristics of the coil component.

Coil components used in high-frequency circuits include a winding portion having a small number of turns (e.g., 1.5 to 2.5 turns). With a smaller number of turns of the winding portion, the length of the lead-out portions is larger relative to the entire length of the coil conductor. Therefore, for coil components including a winding portion having a small number of turns, the shape and arrangement of the lead-out portions have a large effect on the magnetic characteristics and the DC superposition characteristics of the coil component.

### SUMMARY

One object of the present disclosure is to provide a coil component having improved characteristics obtained by improved lead-out portions.

Other objects of the disclosure will be made apparent through the entire description in the specification. The invention disclosed herein may also address drawbacks other than that grasped from the above description.

A coil component according to one embodiment comprises: a base body made of a magnetic material and having a mounting surface; a first external electrode provided on the mounting surface; a second external electrode provided on the mounting surface, the second external electrode being spaced apart from the first external electrode; and a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode. In one embodiment, the first lead-out portion includes a first top-side shaft portion extending from one end of the winding portion along the coil axis, a first bottom-side shaft portion located closer to the coil axis than the first top-side shaft portion and extending from the first external electrode along the coil axis, and a first connection portion connecting between the first top-side shaft portion and the first bottom-side shaft portion.

### Advantageous Effects

According to one embodiment of the present disclosure, the characteristics of the coil component can be improved with improved lead-out portions.

### BRIEF DESCRIPTION OF THE DRAWINGS

FIG. 1 is a perspective view schematically showing a coil component according to one embodiment.

FIG. 2 is an exploded perspective view of the coil component shown in FIG. 1.

FIG. 3A is a plan view showing a conductor pattern provided on a magnetic film 11 shown in FIG. 2.

FIG. 3B is a plan view showing a conductor pattern provided on a magnetic film 12 shown in FIG. 2.

FIG. 3C is a plan view showing a conductor pattern provided on a magnetic film 13 shown in FIG. 2.

FIG. 3D is a plan view showing a conductor pattern provided on a magnetic film 14 shown in FIG. 2.

FIG. 4 is a transparent view of the coil component of FIG. 1 as viewed from the direction of W axis.

FIG. 5 is an enlarged view showing a part of the coil component of FIG. 1.

FIG. 6 is an enlarged view showing a part of a coil component according to another embodiment.

FIG. 7 is an enlarged view showing a part of a coil component according to another embodiment.

FIG. 8 is a plan view showing a magnetic film 13, a first connection portion C21, and a second connection portion C22 of a coil component according to another embodiment.

FIG. 9 is a perspective view schematically showing a coil component according to another embodiment.

FIG. 10 is an exploded perspective view of the coil component shown in FIG. 9.

FIG. 11A is a plan view showing a conductor pattern provided on a magnetic film 111 shown in FIG. 10.

FIG. 11B is a plan view showing a conductor pattern provided on a magnetic film 112 shown in FIG. 10.

FIG. 11C is a plan view showing a conductor pattern provided on a magnetic film 113 shown in FIG. 10.

FIG. 11D is a plan view showing a conductor pattern provided on a magnetic film 114 shown in FIG. 10.

FIG. 11E is a plan view showing a conductor pattern provided on a magnetic film 115 shown in FIG. 10.

FIG. 11F is a plan view showing a conductor pattern provided on a magnetic film 116 shown in FIG. 10.

FIG. 11G is a plan view showing a conductor pattern provided on a magnetic film 117 shown in FIG. 10.

### DESCRIPTION OF THE PREFERRED EMBODIMENTS

Various embodiments of the present invention will be described hereinafter with reference to the appended drawings. Throughout the drawings, the same components common in the drawings are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

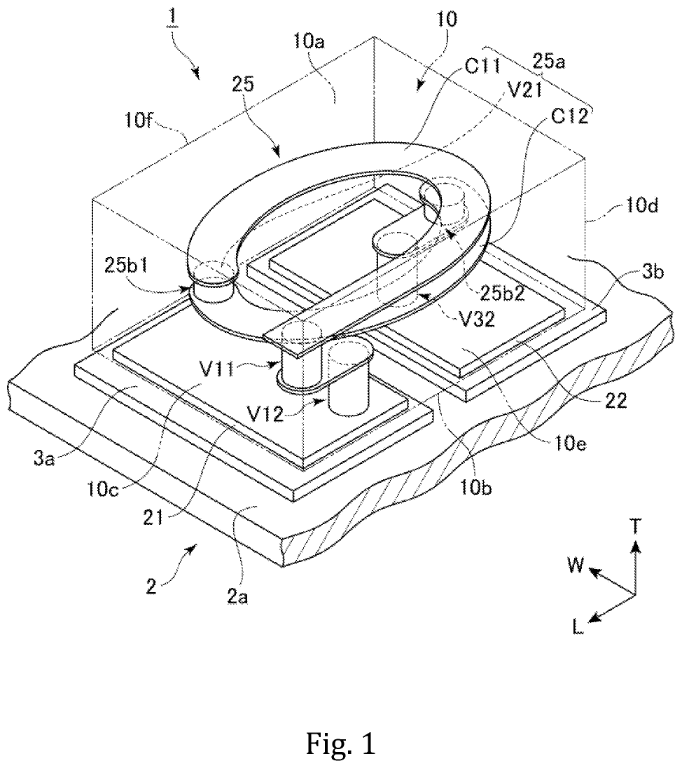

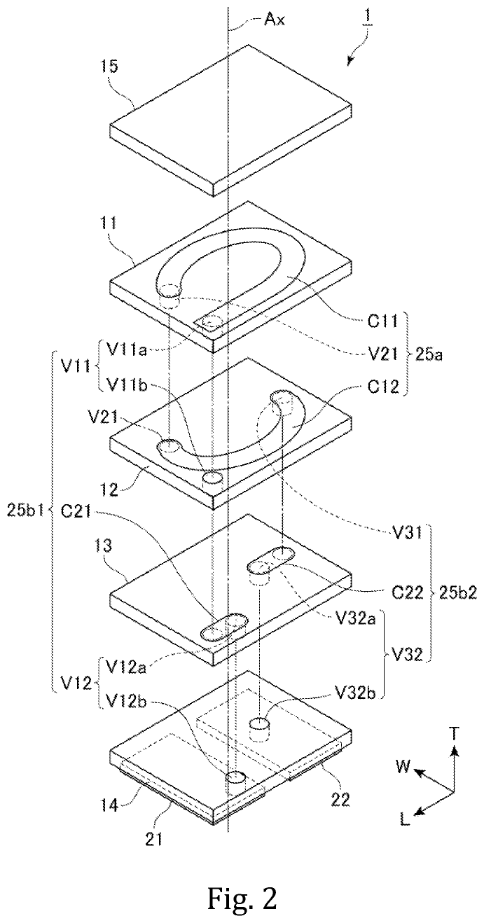

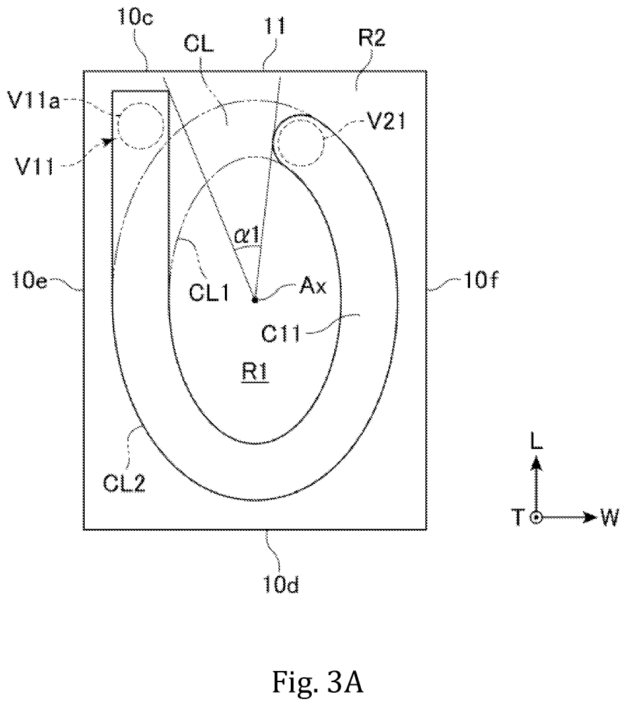

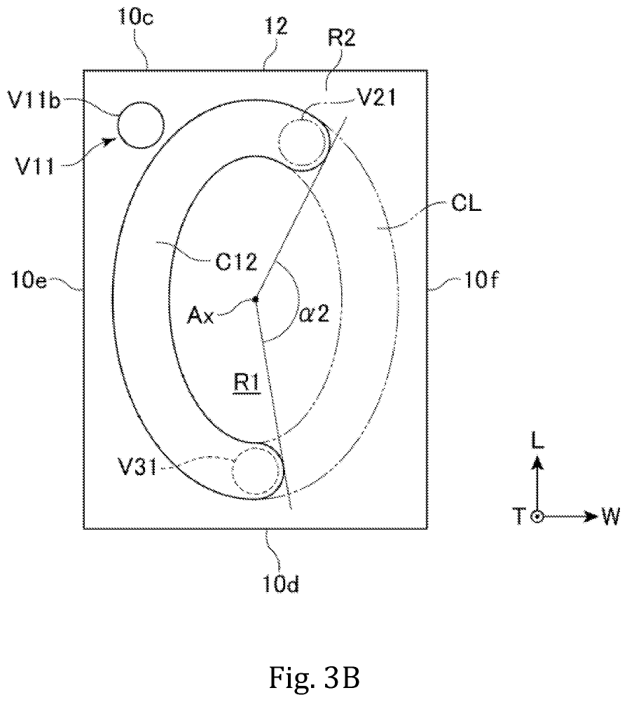

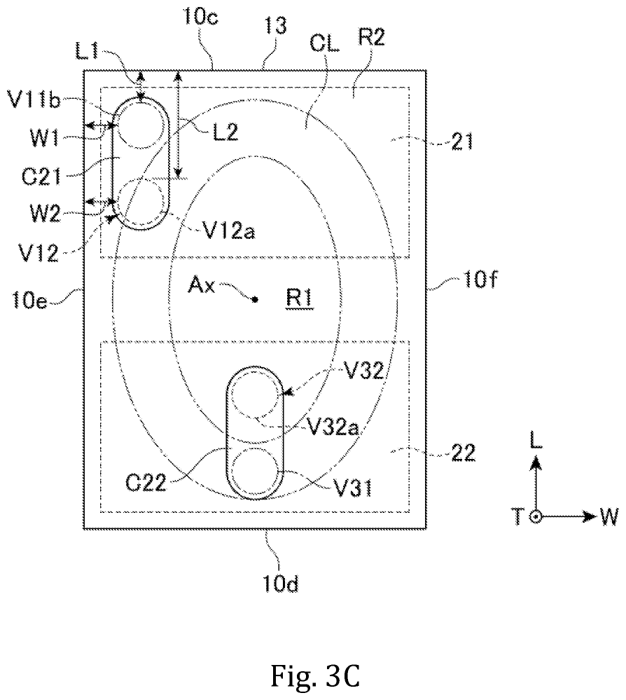

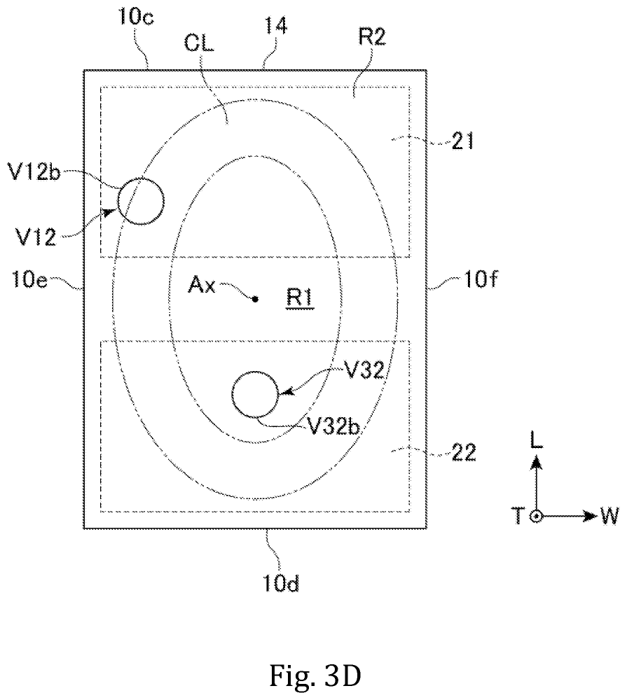

Attempts have conventionally been made to improve the magnetic characteristics and the DC superposition characteristics of coil components, mainly by improving the shape and arrangement of the winding portion. By contrast, the Inventor of the present application has focused on the fact that, in coil components including a coil conductor having a winding portion with a small number of turns, the lead-out portions greatly affect the characteristics of the coil component, and has found that the magnetic characteristics and the DC superposition characteristics of the coil component can be improved through improvement of the lead-out portions. The following description provides an overview of the coil component 1 with reference to FIGS. 1 and 2 and then provides details of the improvement in the lead-out portions with further reference to FIGS. 3A to 3D, 4, and 5.

FIG. 1 is a schematic perspective view of the coil component 1, and FIG. 2 is an exploded perspective view of the coil component 1. By way of one example of the coil component 1, FIGS. 1 and 2 show a laminated inductor. The laminated inductor shown is an example of the coil component 1 to which the invention can be applied. The invention can also be applied to various coil components other than the laminated inductor. For example, the coil component 1 may be a wire-wound coil.

As shown, the coil component 1 includes a base body 10, a coil conductor provided in the base body 10, a first external electrode 21 disposed on a surface of the base body 10, and a second external electrode 22 disposed on the surface of the base body 10 at a position spaced apart from the first external electrode 21. The first external electrode 21 is electrically connected to one end of the coil conductor 25, and the second external electrode 22 is electrically connected to the other end of the coil conductor 25.

The coil conductor 25 includes a winding portion 25a, a first lead-out portion 25b1, and a second lead-out portion 25b2. The first lead-out portion 25b1 connects between one end of the winding portion 25a and the first external electrode 21. The second lead-out portion 25b2 connects between the other end of the winding portion 25a and the second external electrode 22.

The surface of the coil conductor 25 may be covered by an insulating film (not shown) composed of insulating material having a good insulation property. The insulating film may be an oxide film formed on the surface of the coil conductor 25 during the heat treatment in the manufacturing process of the coil component 1. The insulating film may be a coating film composed of resin having a good insulation property, such as polyurethane, polyamide imide, polyimide, polyester, polyester imide.

The coil component 1 may be mounted on a mounting substrate 2a. The mounting substrate 2a has lands 3a and 3b provided thereon. The coil component 1 is mounted on the mounting substrate 2a by bonding the first external electrode 21 to the land 3a and bonding the second external electrode 22 to the land 3b. A circuit board 2 according to one embodiment of the present invention includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In one embodiment, the base body 10 is formed of a magnetic material into a rectangular parallelepiped shape. For example, the coil component 1 has a dimension in the L axis direction (length) of 0.5 mm to 6.0 mm, a dimension in the W axis direction (width) of 0.3 mm to 4.5 mm, and a dimension in the T axis direction (height) of 0.3 mm to 4.5 mm. In one embodiment, the length of the coil component 1 may be larger than the width thereof. The term “rectangular parallelepiped” or “rectangular parallelepiped shape” used herein is not intended to mean solely “rectangular parallelepiped” in a mathematically strict sense. As described later, the corners and/or edges of the base body 10 may be rounded. The dimensions and the shape of the base body 10 are not limited to those specified herein.

In the coil component 1, the first lead-out portion 25b1 and/or the second lead-out portion 25b2 of the coil conductor 25 is improved to improve the magnetic characteristics and the DC superposition characteristics, and therefore, the improved magnetic characteristics and DC superposition characteristics can be obtained without increasing the diameter of the winding portion 25a. Therefore, the external dimensions of the coil component 1 required to obtain a given inductance can be smaller than those of conventional coil components. In one embodiment, the largest of the length, width, and height of the coil component 1 may be 2.0 mm or less. In the illustrated embodiment, the length and the width of the coil component 1 correspond to the length and the width of the base body 10, respectively. The largest of the length, width, and height of the coil component 1 may be 1.5 mm or less or may be 1.0 mm or less. The volume of the coil component 1 may be 2.0 mm 3 or less, 1.5 mm 3 or less, or 1.0 mm 3 or less.

The base body 10 has a first principal surface 10a, a second principal surface 10b, a first end surface 10c, a second end surface 10d, a first side surface 10e, and a second side surface 10f. Each of the first end surface 10c, the second end surface 10d, the first side surface 10e, and the second side surface 10f is connected to the second principal surface 10b. The first end surface 10c connects between the first side surface 10e and the second side surface 10f. The second end surface 10d also connects between the first side surface 10e and the second side surface 10f. The corners and/or edges of the base body 10 may be rounded. When the edges of the base body 10 are rounded, any two of the first principal surface 10a, the second principal surface 10b, the first end surface 10c, the second end surface 10d, the first side surface 10e, and the second side surface 10f adjacent to each other are connected via a rounded surface. Thus, each of the first end surface 10c, the second end surface 10d, the first side surface 10e, and the second side surface 10f is connected to the second principal surface 10b directly or indirectly via a rounded surface. When the edges of the base body 10 are rounded, the outer surface of the base body 10 is defined by the first principal surface 10a, the second principal surface 10b, the first end surface 10c, the second end surface 10d, the first side surface 10e, the second side surface and the rounded surfaces connecting between any two of these surfaces adjacent to each other.

The first principal surface 10a and the second principal surface 10b are at the opposite ends in the height direction of the base body 10, the first end surface 10c and the second end surface 10d are at the opposite ends in the length direction of the base body and the first side surface 10e and the second side surface 10f are at the opposite ends in the width direction of the base body 10. As shown in FIG. 1, the first principal surface 10a is at the top of the base body 10, and therefore, the first principal surface 10a may be referred to as a “top surface.” Likewise, the second principal surface 10b may be referred to as a “lower surface” or “bottom surface.” Since the coil component 1 is disposed such that the second principal surface 10b faces the mounting substrate 2a, the second principal surface may be herein referred to as “the mounting surface.” The top surface 10a and the bottom surface 10b are separated from each other by a distance equal to the height of the base body 10, the first end surface 10c and the second end surface 10d are separated from each other by a distance equal to the length of the base body 10, and the first side surface and the second side surface 10f are separated from each other by a distance equal to the width of the base body 10.

The base body 10 is made of a magnetic material. The magnetic material for use in the base body 10 may be a soft magnetic alloy material, a composite magnetic material including magnetic particles dispersed in a resin, a ferrite material, or any other known magnetic materials.

The soft magnetic metal particles contained in the magnetic material for use in the base body 10 may include at least one of the elements Fe, Ni, and Co as a main component and at least one of the elements Si, Cr, Al, B, and P as an additive. The soft magnetic metal particles contained in the magnetic material for the base body 10 are, for example, particles of a crystalline alloy such as an Fe—Si—Cr alloy, an Fe—Si—Al alloy, or an Fe—Ni alloy, an amorphous alloy such as an Fe—Si—Cr—B—C alloy or an Fe—Si—Cr—B alloy, or a mixture thereof. The composition of the soft magnetic metal particles contained in the base body 10 is not limited to those described above. For example, the soft magnetic metal particles contained in the base body 10 may be particles of a Co—Nb—Zr alloy, an Fe—Zr—Cu—B alloy, an Fe—Si—B alloy, an Fe—Co—Zr—Cu—B alloy, an Ni—Si—B alloy, or an Fe—Al—Cr alloy.

An insulating film may be provided on a surface of each of the soft magnetic metal particles contained in the base body 10. The insulating films may be oxide films formed by oxidation of the elements included in the soft magnetic metal particles contained in the magnetic material.

In one or more embodiments, the average particle size of the soft magnetic metal particles contained in the base body 10 is, for example, from 1 μm to 40 μm. The base body 10 may contain two or more types of soft magnetic metal particles having different average particle sizes. The soft magnetic metal particles contained in the base body 10 may include, in addition to first soft magnetic metal particles having an average particle size of 1 μm to 40 μm, second soft magnetic metal particles having an average particle size smaller than that of the first soft magnetic metal particles. The average particle size of the second soft magnetic metal particles is, for example, 0.1 μm to 0.5 μm. Two or more types of soft magnetic metal particles having different average particle sizes are contained in the base body 10 to increase the filling factor of the soft magnetic metal particles in the magnetic base body. The volume proportion of the soft magnetic metal particles in the entire volume of the base body 10 may be 85 vol % or more, or 88 vol % or more. The magnetic characteristics of the base body 10 can be enhanced by raising the filling factor of the soft magnetic metal particles in the base body 10. The mechanical strength of the base body 10 can also be increased by raising the filling factor of the soft magnetic metal particles in the base body 10. The average particle size of the soft magnetic metal particles contained in the base body 10 is determined in the following manner. The base body 10 is cut along the thickness direction (the T axis direction) to expose a section. The section is photographed using a scanning electron microscope (SEM) to obtain a SEM image, and the volume-weighted particle size distribution is determined based on the SEM image. The particle size distribution is used to determine the average particle size. For example, the average particle size (the median diameter (D50)) calculated based on the volume-weighted particle size distribution obtained based on the SEM image can be used as the average particle size of the soft magnetic metal particles contained in the base body 10. The particle size of the first soft magnetic metal particles may be distributed in the range of 1 to 60 μm. The particle size of the second soft magnetic metal particles may be distributed in the range of 0.01 to 1 μm.

In the base body 10, the soft magnetic metal particles may be bonded to each other with an oxide film formed by oxidation of an element included in the soft magnetic metal particles during a manufacturing process. The base body 10 may contain a binder in addition to the soft magnetic metal particles. When the base body 10 contains a binder, the soft magnetic metal particles may be bonded to each other by the binder. The binder in the base body 10 may be formed, for example, by curing a thermosetting resin that has an excellent insulation property. Examples of a material for such a binder include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin. The binder contained in the base body 10 is not limited to those described above. For example, the binder contained in the base body 10 may be glass.

As shown in FIG. 2, the base body 10 includes magnetic films 11 to 15. The base body 10 is a laminate formed of the magnetic films 11 to 15 stacked together. However, the boundaries between the magnetic films 11 to 15 may not be visible when a section of the base body 10 is observed under SEM. Of these magnetic films, the magnetic films 11 to 13 have a conductor pattern formed on the top-side surface thereof. Specifically, the magnetic film 11 has a first conductor pattern C11 formed on the top-side surface thereof, and the magnetic film 12 has a second conductor pattern C12 formed on the top-side surface thereof. Each of the first conductor pattern C11 and the second conductor pattern C12 extends in the circumferential direction around a coil axis Ax that extends along the T axis direction. For example, the coil axis Ax extends through the intersection of the two diagonal lines of the magnetic film 11, which has a rectangular shape in plan view. The coil axis Ax may extend through the geometric center of the magnetic film 11 in plan view. The magnetic film 13 has connection portions C21 and C22 formed on the top-side surface thereof. The connection portions C21 and C22 are conductor patterns for connecting between via conductors. Each of the magnetic films 11 to 14 has through holes formed at predetermined positions to extend through the magnetic film in the T axis direction, and the via conductors are embedded in these through holes. The conductor patters and the via conductors of the coil component 1 are formed as follows: a conductive paste formed of a metal or an alloy having an excellent conductivity is printed by screen printing on magnetic sheets that are precursor of the magnetic films 11 to 14, and the conductive paste printed on the magnetic sheets is heated. The conductive paste may be made of Ag, Pd, Cu, Al, or alloys thereof. The conductor patterns and the via conductors of the coil component 1 may be formed of materials other than described above. For example, the conductor patterns and the via conductors of the coil component 1 may be formed by sputtering, ink-jetting, or other known methods.

Although the magnetic film 11 is illustrated as a single-layer sheet-like member, the magnetic film 11 may be a laminate of a plurality of sheet-like members. Likewise, each of the magnetic films 12 to 15 may be a laminate of a plurality of sheet-like members. The thickness of each of the magnetic films 11 to 15 can be adjusted by adjusting the number of sheets that make up the magnetic films 11 to 15.

Next, with further reference to FIGS. 3A to 3D, a further description is given of the conductor patterns and the via conductors of the coil component 1.

As shown in FIG. 3A, the first conductor pattern C11 is formed on the top-side surface of the magnetic film 11. The first conductor pattern C11 extends in the circumferential direction around the coil axis Ax within a plane orthogonal to the coil axis Ax (the LW plane) for less than one turn. The number of turns of a conductor pattern extending in the circumferential direction around the coil axis Ax refers to the proportion of the region spanned by the conductor pattern in the circumferential direction. For example, the number of turns of a conductor pattern can be expressed by the central angle of the region spanned by the conductor pattern around the coil axis Ax. In the embodiment shown, the first conductor pattern C11 extends over the central angle (360°−α1) in the circumferential direction around the coil axis Ax, and thus the number of turns of the first conductor pattern C11 can be expressed by (1−α1/360). For example, if α1 is 30°, the number of turns of the first conductor pattern C11 is about 0.91.

The magnetic film 11 has a through hole extending therethrough in the T axis direction at the region overlapping with one end of the first conductor pattern C11, and a via conductor Vila is embedded in this through hole. The magnetic film 11 also has a through hole extending therethrough in the T axis direction at the region overlapping with the other end of the first conductor pattern C11, and a via conductor V21 is embedded in this through hole.

As shown in FIG. 3B, the second conductor pattern C12 is formed on the top-side surface of the magnetic film 12. The second conductor pattern C12 extends in the circumferential direction around the coil axis Ax within a plane orthogonal to the coil axis Ax (the LW plane) for less than one turn. In the embodiment shown, the second conductor pattern C12 extends over the central angle (360°−α2) in the circumferential direction around the coil axis Ax. Thus, the number of turns of the second conductor pattern C12 can be expressed by (1−α2/360). For example, if α2 is 120°, the number of turns of the second conductor pattern C12 is about 0.67. One end of the second conductor pattern C12 is connected to the via conductor V21. The magnetic film 12 has a through hole extending therethrough in the T axis direction at the region overlapping with the other end of the second conductor pattern C12, and a via conductor V31 is embedded in this through hole. The other end of the second conductor pattern C12 is connected to the via conductor V31.

The magnetic film 12 has a through hole extending therethrough in the T axis direction at the region overlapping with the via conductor Vila in plan view, and a via conductor V11b is embedded in this through hole. The via conductor V11b is connected to the via conductor Vila.

As shown in FIG. 3C, a first connection portion C21 and a second connection portion C22 are formed on the top-side surface of the magnetic film 13. One end of the first connection portion C21 is connected to the via conductor V11b. The magnetic film 13 has a through hole extending therethrough in the T axis direction at the region overlapping with the other end of the first connection portion C21, and a via conductor V12a is embedded in this through hole. The other end of the first connection portion C21 is connected to the via conductor V12a. Thus, on the top-side surface of the magnetic film 13, the first connection portion C21 extends from one end thereof connected to the via conductor V11b to the other end thereof connected to the via conductor V12a.

One end of the second connection portion C22 is connected to the via conductor V31. The magnetic film 13 has a through hole extending therethrough in the T axis direction at the region overlapping with the other end of the second connection portion C22, and a via conductor V32a is embedded in this through hole. The other end of the second connection portion C22 is connected to the via conductor V32a. Thus, on the top-side surface of the magnetic film 13, the second connection portion C22 extends from one end thereof connected to the via conductor V31 to the other end thereof connected to the via conductor V32a.

The first connection portion C21 may extend straight along the LW plane. The straight shape of the first connection portion C21 can inhibit the increase of DC resistance Rdc due to the first connection portion C21. Likewise, the second connection portion C22 may also extend straight along the LW plane. The straight shape of the second connection portion C22 can inhibit the increase of DC resistance Rdc due to the second connection portion C22.

As shown in FIG. 3D, the magnetic film 14 has through holes extending therethrough in the T axis direction at the region overlapping with the via conductor V12a and the region overlapping with the via conductor V32a in plan view. A via conductor V12b is embedded in the through hole formed in the region overlapping with the via conductor V12a, and a via conductor V32b is embedded in the through hole formed in the region overlapping with the via conductor V32a. The top-side end of the via conductor V12b is connected to the bottom-side end of the via conductor V12a, and the bottom-side end of the via conductor V12b is connected to the first external electrode 21. The top-side end of the via conductor V32b is connected to the bottom-side end of the via conductor V32a, and the bottom-side end of the via conductor V32b is connected to the second external electrode 22.

As described above, the first conductor pattern C11 and the second conductor pattern C12 are connected by the via conductor V21. The first conductor pattern C11, the via conductor V21, and the second conductor pattern C12 connected in this manner constitute a winding portion 25a having a spiral shape and extending for 1.5 turns around the coil axis Ax in the base body 10. When the coil component 1 is viewed in plan view (from the T axis direction), a part of the winding portion 25a extends for one or more turns along a closed loop path CL having an elliptical shape. The closed loop path CL refers to the region between the inner peripheral surface CL1 having an elliptical shape and the outer peripheral surface CL2 having an elliptical shape with a diameter larger than that of the inner peripheral surface CL1. Since the via conductor Vila is located near the upper left corner of the magnetic film 11, a part of the winding portion 25a diverges from the closed loop path CL and extends toward the via conductor Vila. The shape of the closed loop path CL is not limited to an elliptical shape. The shape of the closed loop path CL in plan view may be an oval, circle, rectangle, polygon, or any other shape.

The region of the base body 10 located inside the closed loop path CL in plan view is referred to as the inner region R1, and the region of the base body 10 located outside the closed loop path CL in plan view is referred to as the outer region R2.

In one embodiment, the number of turns of the winding portion 25a is 3 or less. For example, the number of turns of the winding portion 25a ranges from 1.3 to 2.5. With a smaller number of turns of the winding portion 25a, the lengths of the first lead-out portion 25b1 and the second lead-out portion 25b2 are larger relative to the entire length of the coil conductor 25. In particular, when the number of turns of the winding portion is 3 or less, the lengths of the first lead-out portion 25b1 and the second lead-out portion 25b2 account for a large proportion of the entire length of the coil conductor 25, and thus the shape and arrangement of the first lead-out portion 25b1 and the second lead-out portion 25b2 have a large effect on the characteristics of the coil component 1. The shape and arrangement of the first lead-out portion 25b1 and the second lead-out portion in the coil component 1 are improved such that the coil component 1 has excellent magnetic characteristics and DC superposition characteristics, as described below.

One end of the winding portion 25a is connected to the first external electrode 21 via the via conductor Vila, the via conductor V11b, the first connection portion C21, the via conductor V12a, and the via conductor V12b. Thus, the first lead-out portion 25b1 is constituted by the via conductor Vila, the via conductor V11b, the first connection portion C21, the via conductor V12a, and the via conductor V12b. The via conductors Vila and V11b are located on the same axis extending parallel to the T axis, and thus the via conductors Vila and V11b are collectively referred to as the first top-side shaft portion V11. The first top-side shaft portion V11 is constituted by the via conductor Vila and the via conductor V11b. The via conductors V12a and V12b are located on the same axis extending parallel to the T-axis and are positioned lower (closer to the mounting surface 10b) than the first top-side shaft portion V11, and thus the via conductors V12a and V12b are collectively referred to as the first bottom-side shaft portion V12. The first bottom-side shaft portion V12 is constituted by the via conductor V12a and the via conductor V12b. As described above, one end of the winding portion 25a is connected to the first external electrode 21 via the first lead-out portion 25b1, which is constituted by the first top-side shaft portion V11, the first connection portion C21, and the first bottom-side shaft portion V12. When top-side and bottom-side positions of the coil component 1 or its components are herein referred to, unless they should be interpreted otherwise, the direction closer to the mounting substrate 2a is the “bottom side,” and the direction farther from the mounting substrate 2a is the “top side,” in the attitude in which the coil component 1 is mounted on the mounting substrate 2a. Since the first top-side shaft portion V11 is located farther from the mounting substrate 2a than the first bottom-side shaft portion V12, the first top-side shaft portion V11 is located on the “top side” of the first bottom-side shaft portion V12. Using the coordinate axes shown in FIG. 1 to represent the top-bottom direction, the positive direction in the T-axis is the “top side,” and the negative side in the T-axis direction is the “bottom side.” Note that the top-bottom direction does not necessarily coincide with the vertical direction depending on the orientation of the mounting substrate 2a.

The other end of the winding portion 25a is connected to the second external electrode 22 via the via conductor V31, the second connection portion C22, the via conductor V32a, and the via conductor V32b. Thus, the second lead-out portion 25b2 is constituted by the via conductor V31, the second connection portion C22, the via conductor V32a, and the via conductor V32b. The via conductors V32a and V32b are located on the same axis extending parallel to the T axis, and thus the via conductors V32a and V32b are collectively referred to as the second bottom-side shaft portion V32. The second bottom-side shaft portion V32 is constituted by the via conductor V32a and the via conductor V32b. The via conductor V31, which extends in the T axis direction and is located higher (farther from the mounting surface 10b) than the second bottom-side shaft portion V32, may be referred to as the second top-side shaft portion V31. As described above, the other end of the winding portion 25a is connected to the second external electrode 22 via the second lead-out portion 25b2, which is constituted by the second top-side shaft portion V31, the second connection portion C22, and the second bottom-side shaft portion V32.

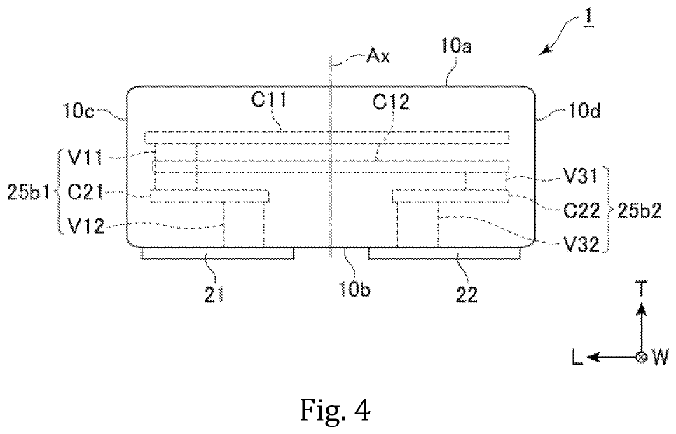

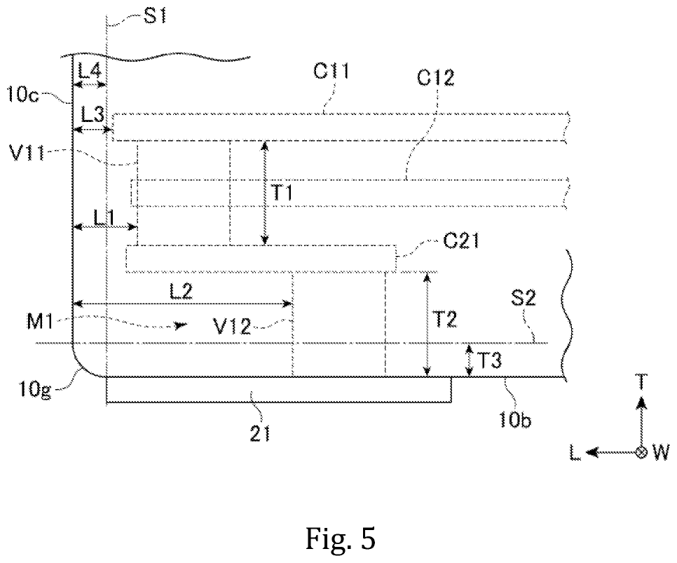

With further reference to FIGS. 4 and 5, the first lead-out portion 25b1 and the second lead-out portion 25b2 will be further described. In one embodiment as shown in FIG. 4, when the coil component 1 is viewed from the front (viewed from the W-axis direction), the first bottom-side shaft portion V12 of the first lead-out portion 25b1 is positioned closer to the coil axis Ax than the first top-side shaft portion V11. To determine which of the first top-side shaft portion V11 and the first bottom-side shaft portion V12 is closer to the coil axis Ax, the distance between the coil axis Ax and the portion of the first top-side shaft portion V11 that is closest to the first end surface 10c (the left end of the first top-side shaft portion V11 in the point of view shown in FIG. 4) is compared to the distance between the coil axis Ax and the portion of the first bottom-side shaft portion V12 that is closest to the first end surface 10c (the left end of the first bottom-side shaft portion V12 in the point of view shown in FIG. 4). Therefore, when the distance between the coil axis Ax and the portion of the first bottom-side shaft portion V12 that is closest to the first end surface 10c is smaller than the distance between the coil axis Ax and the portion of the first top-side shaft portion V11 that is closest to the first end surface 10c, it can be determined that the first bottom-side shaft portion V12 is positioned closer to the coil axis Ax than the first top-side shaft portion V11.

The arrangement of the first top-side shaft portion V11 and the first bottom-side shaft portion V12 may be defined with respect to the distances from the first top-side shaft portion V11 and the first bottom-side shaft portion V12 to the first end surface 10c and the first side surface 10e, instead of the distances to the coil axis Ax. As shown in FIG. 3C, the first top-side shaft portion V11 is spaced from the first end surface by a distance L1 and spaced from the first side surface 10e by a distance W1. In other words, the distance between the first top-side shaft portion V11 and the first end surface is L1, and the distance between the first top-side shaft portion V11 and the first side surface 10e is W1. The first bottom-side shaft portion V12 is spaced from the first end surface 10c by a distance L2 and spaced from the first side surface 10e by a distance W2. In other words, the distance between the first bottom-side shaft portion V12 and the first end surface 10c is L2, and the distance between the first bottom-side shaft portion V12 and the first side surface 10e is W2. In one embodiment, the first bottom-side shaft portion V12 is positioned in the base body 10 such that (1) the distance L2 between the first bottom-side shaft portion V12 and the first end surface 10c is larger than the distance L1 between the first top-side shaft portion V11 and the first end surface 10c, and the distance W2 between the first bottom-side shaft portion V12 and the first side surface 10e is larger than or equal to the distance W1 between the first top-side shaft portion V11 and the first side surface 10e (i.e., L2>L1 and W2≥W1), or (2) the distance L2 between the first bottom-side shaft portion V12 and the first end surface 10c is larger than or equal to the distance L1 between the first top-side shaft portion V11 and the first end surface 10c, and the distance W2 between the first bottom-side shaft portion V12 and the first side surface 10e is larger than the distance W1 between the first top-side shaft portion V11 and the first side surface 10e (i.e., L2≥L1 and W2>W1). FIG. 3C illustrates the aspect of (1) above. Specifically, the relationship L2>L1 and W1=W2 is established in FIG. 3C.

As can be seen from the plan view of FIG. 3C, the first top-side shaft portion V11 is located in the outer region R2, which is outside the closed loop path CL in the radial direction around the coil axis Ax, whereas the first bottom-side shaft portion V12 is located to overlap with the closed loop path CL. The arrangement of the first top-side shaft portion V11 and the first bottom-side shaft portion V12 is not limited to the above locations.

As shown in FIG. 4, when the coil component 1 is viewed from the front (viewed from the W-axis direction), the second bottom-side shaft portion V32 of the second lead-out portion 25b2 is positioned closer to the coil axis Ax than the second top-side shaft portion V31. As can be seen from the plan view of FIG. 3C, the second top-side shaft portion V31 is located to overlap with the closed loop path CL, whereas the second bottom-side shaft portion V32 is located in the inner region R1, which is inside the closed loop path CL. The arrangement of the second top-side shaft portion V31 and the second bottom-side shaft portion V32 is not limited to the above locations. For example, the second top-side shaft portion V31 may be located not to overlap with the closed loop path CL (e.g., in the outer region R2 in plan view). The second bottom-side shaft portion V32 may partially overlap with the closed loop path CL.

As described above, in the front view, the first bottom-side shaft portion V12 is located closer to the coil axis Ax than the first top-side shaft portion V11, and thus as shown in FIG. 5, the distance L2 between the first bottom-side shaft portion V12 and the first end surface 10c is larger than the distance L1 between the first top-side shaft portion V11 and the first end surface 10c. As described in the '391 Publication, a lead-out portion of the coil conductor in conventional coil components extends straight from the end of the winding portion to the mounting surface along the coil axis, and thus the distance between the lead-out portion and the surface of the base body cannot be made larger without increasing the external dimensions of the base body. Therefore, in conventional coil components, the magnetic flux generated when electric current flowing through the coil conductor changes passes through a narrow region between the lead-out portion and the surface of the base body. By contrast, in the coil component 1 according to one embodiment of the invention, the first lead-out portion 25b1 includes a first bottom-side shaft portion V12 located closer to the coil axis Ax than the first top-side shaft portion V11, and thus a margin region M1 having a larger volume than the region between the lead-out portion and the surface of the base body in conventional coil components is present between the first bottom-side shaft portion V12 and the first end surface 10c in the base body 10. The magnetic flux generated when electric current flowing through the first lead-out portion 25b1 changes can pass through this margin region M1, and thus the coil component 1 can have better magnetic characteristics and DC superposition characteristics than conventional coil components in which the magnetic flux passes through a narrow interval between the lead-out portion and the surface of the base body.

As described above, in one embodiment, the first bottom-side shaft portion V12 may be positioned such that the distance L2 between the first bottom-side shaft portion V12 and the first end surface 10c is larger than the distance L1 between the first top-side shaft portion V11 and the first end surface 10c, and the distance W2 between the first bottom-side shaft portion V12 and the first side surface 10e is larger than or equal to the distance W1 between the first top-side shaft portion V11 and the first side surface 10e. In this case, a margin region having a larger volume than the region between the lead-out portion and the surface of the base body in conventional coil components can be provided between the first bottom-side shaft portion V12 and the first side surface 10e as well as between the first bottom-side shaft portion V12 and the first end surface 10c, and thus even better magnetic characteristics and DC superposition characteristics can be provided.

Further, as described above, in one embodiment, the first bottom-side shaft portion V12 may be positioned such that the distance L2 between the first bottom-side shaft portion V12 and the first end surface 10c is larger than or equal to the distance L1 between the first top-side shaft portion V11 and the first end surface 10c, and the distance W2 between the first bottom-side shaft portion V12 and the first side surface 10e is larger than the distance W1 between the first top-side shaft portion V11 and the first side surface 10e. In this case, a margin region having a larger volume than the region between the lead-out portion and the surface of the base body in conventional coil components can be provided between the first bottom-side shaft portion V12 and the first side surface 10e as well as between the first bottom-side shaft portion V12 and the first end surface 10c, and thus even better magnetic characteristics and DC superposition characteristics can be provided.

Thus, in the coil component 1, the magnetic characteristics and the DC superposition characteristics are improved by the first bottom-side shaft portion V12, and thus the first top-side shaft portion V11 can be positioned close to the first end surface 10c. In other words, the desired magnetic characteristics and DC superposition characteristics can be easily achieved in the coil component 1 even if the first top-side shaft portion V11 is positioned close to the first end surface 10c. When the base body 10 contains soft magnetic metal particles, dielectric breakdown may occur between the first top-side shaft portion V11 and a conductor pattern in the winding portion 25a other than the conductor pattern directly contacted by the first top-side shaft portion V11 (in the illustrated example, the first conductor pattern C11). By placing the first top-side shaft portion V11 close to the first end surface 10c, a large distance can be provided between the first top-side shaft portion V11 and the conductor pattern (in the illustrated example, the second conductor pattern C12) other than the conductor pattern directly contacted by the first top-side shaft portion V11 among the conductor patterns constituting the winding portion 25a. This can inhibit dielectric breakdown between the first top-side shaft portion V11 and the conductor pattern other than the conductor pattern directly contacted by the first top-side shaft portion V11 among the conductor patterns constituting the winding portion 25a. When the base body 10 contains soft magnetic metal particles, the dielectric breakdown can be significantly inhibited by positioning the first top-side shaft portion V11 close to the first end surface 10c. The first top-side shaft portion V11 may be positioned such that, in plan view, the distance between the first top-side shaft portion V11 and the first end surface 10c is smaller than the distance between the first top-side shaft portion V11 and the conductor pattern (for example, the second conductor pattern C12) other than the conductor pattern directly contacting the first top-side shaft portion V11 among the conductor patterns constituting the winding portion 25a. The distance between the first top-side shaft portion V11 and the first end surface 10c can be the shortest distance between the surface defining the outer periphery of the first top-side shaft portion V11 and the first end surface 10c in plan view. The distance between the first top-side shaft portion V11 and the conductor pattern other than the conductor pattern directly contacting the first top-side shaft portion V11 among the conductor patterns constituting the winding portion 25a may be the shortest distance between the surface defining the outer periphery of the first top-side shaft portion V11 and the outer peripheral surface of the above conductor pattern (for example, the second conductor pattern C12) in plan view.

When the coil component 1 operates, electric current flows through the coil conductor 25, and the temperature of the coil conductor 25 rises. At this time, stresses act from the coil conductor 25 to the base body 10 due to the difference in the linear expansion coefficient between the base body 10 and the coil conductor 25. In conventional coil components, the lead-out portion of the coil conductor extends straight from one end of the winding portion to the external electrode, and thus the stresses acting from the lead-out portion to the base body is biased in a direction perpendicular to the direction of extension of the lead-out portion. These stresses acting in a uniform direction from the lead-out portion to the base body can cause cracking between the lead-out portion and the base body. By contrast, in the coil component 1, the portion of the first lead-out portion 25b1 that extends in the T-axis direction is divided into the first top-side shaft portion V11 and the first bottom-side shaft portion V12, and the first top-side shaft portion V11 and the first bottom-side shaft portion V12 are connected by the first connection portion C21 that extends perpendicular to the T axis. Therefore, when the temperature of the coil conductor rises, stresses act from the coil conductor 25 to the base body 10 in various directions. This inhibits the occurrence of cracking between the first lead-out portion 25b1 and the base body 10.

The coil conductor 25 is formed by heating a conductive paste together with the magnetic sheets, which are precursors of the magnetic films 11 to 14. Since the conductive paste heated has a different linear expansion coefficient than the magnetic sheets, stresses produced by the difference in linear expansion coefficient act from the first lead-out portion 25b1 (or its precursor, the conductive paste) to the base body 10 (or its precursor, the magnetic sheets) even during heating for forming the coil conductor 25. In the coil component 1, the first top-side shaft portion V11 and the first bottom-side shaft portion V12 are connected by the first connection portion C21 extending in a direction perpendicular to the T-axis, and thus the direction of stresses acting from the first lead-out portion 25b1 to the base body 10 during the heating step in the manufacturing process can be varied. This inhibits cracking between the first lead-out portion 25b1 and the base body 10.

When the coil component 1 is mounted on the mounting substrate 2a, the mounting substrate 2a undergoes thermal expansion and contraction, and thus stresses act from the mounting substrate 2a to the base body 10 and the first lead-out portion 25b1. Since the first lead-out portion 25b1 includes the first top-side shaft portion V11 and the first bottom-side shaft portion V12 extending in the direction parallel to the T axis and the first connection portion C21 extending in a direction perpendicular to the T axis, even when stresses act from the mounting substrate 2a to the base body 10 and the first lead-out portion 25b1, cracking between the first lead-out portion 25b1 and the base body 10 can be inhibited.

For the same reason as described for the first lead-out portion 25b1, cracking between the second lead-out portion 25b2 and the base body 10 is also inhibited.

As shown in FIG. 5, in the first lead-out portion 25b1, the dimension T2 of the first bottom-side shaft portion V12 in the T axis direction may be larger than the dimension T1 of the first top-side shaft portion V11 in the T axis direction. With the dimension T2 larger than the dimension T1, the volume of margin region M1 can be further increased, resulting in further improved magnetic characteristics and DC superposition characteristics of the coil component 1 compared to the case where the dimension T2 is smaller than the dimension T1. Likewise, in the second lead-out portion 25b2, the dimension of the second bottom-side shaft portion V32 in the T axis direction can be larger than that of the second top-side shaft portion V31 in the T axis direction. This enhances the improvement of the magnetic characteristics and the DC superposition characteristics by the second bottom-side shaft portion V32.

In conventional coil components, a larger distance between the lead-out portion and the surface of the base body makes it possible to secure a larger region in the base body penetrated by the magnetic flux generated by the change in the current flowing in the lead-out portion. However, uniformly increasing the distance between the lead-out portion and the surface of the base body leads to a larger size of the coil component. In the coil component 1 according to one embodiment of the invention, the first bottom-side shaft portion V12 is positioned closer to the coil axis Ax than the first top-side shaft portion V11, thereby improving the magnetic characteristics and the DC superposition characteristics of the coil component 1 without increasing the size of the coil component 1. In one embodiment, the first bottom-side shaft portion V12 is positioned to overlap with the winding portion 25a in plan view. Thus, the first bottom-side shaft portion V12 is positioned in the region between the winding portion 25a and the mounting surface 10b in the base body 10, such that the first bottom-side shaft portion V12 can be positioned close to the coil axis Ax without interfering with other portions of the coil conductor 25.

As shown in FIG. 5, the base body 10 may have a rounded surface 10g connecting the mounting surface 10b and the first end surface 10c. When the coil component 1 undergoes an impact of dropping or other impacts, the stresses from those impacts tend to concentrate in the corners and edges of the coil component 1. Due to the weight of the first external electrode 21 and the second external electrode 22 provided on the mounting surface 10b, the dropped coil component 1 tends to collide with the ground at the edge on the boundary between the mounting surface 10b and the first end surface or at the edge on the boundary between the mounting surface 10b and the second end surface 10d. Since the rounded surface 10g connects the mounting surface 10b and the first end surface 10c of the base body 10, stresses from an impact of dropping or other impacts can be distributed to inhibit damage to the coil component 1. Likewise, the mounting surface 10b and the second end surface 10d of the base 10 may be connected by a rounded surface. Other edges of the base body 10 may also be configured as rounded surfaces, assuming that other external impacts can be applied to the coil component 1 in addition to the impact of dropping.

In the coil component 1, the first bottom-side shaft portion V12 is positioned farther from the first end surface 10c than the first top-side shaft portion V11, and thus the thickness of the base body 10 near the edge connecting the first end surface and the mounting surface 10b can be larger than in conventional coil components in which the lead-out portion extends at a uniform and narrow interval from the surface of the base body. This improves the mechanical strength of the region in the base body 10 near the edge connecting the first end surface 10c and the mounting surface 10b, where stresses from impacts tend to concentrate.

Assume a first imaginary plane 51 shown in FIG. 5 that passes through the boundary between the mounting surface 10b and the rounded surface 10g and extends parallel to the coil axis Ax. The first imaginary plane 51 extends parallel to the first end surface 10c. The distance L3 between the portion of the winding portion 25a closest to the first end surface 10c and the first end surface 10c may be larger than the distance L4 between the first imaginary plane Si and the first end surface 10c. This allows a distance larger than the distance L4 to be secured between the winding portion 25a and the first end surface 10c of the base body 10, thus ensuring insulation between the winding portion and conductive members provided outside the coil component 1.

In one embodiment, the first external electrode 21 may be positioned such that the left end of the first external electrode 21 (the end in the positive direction along the L axis) is aligned with the first imaginary plane S1 as the coil component 1 is viewed from the front. This allows the first external electrode 21 to be firmly attached to the mounting surface 10b.

The first bottom-side shaft portion V12 is positioned inside the first imaginary plane S1 so as not to intersect the first imaginary plane Si. Thus, the first bottom-side shaft portion V12 is exposed to the outside of the base body 10 through the mounting surface 10b formed flat instead of the rounded surface 10g. This configuration allows a larger contact area between the end surface of the first bottom-side shaft portion V12 and the first external electrode 21 provided on the mounting surface 10b, such that electric connection between the first bottom-side shaft portion V12 and the first external electrode 21 can be secured, and firm bonding between the first bottom-side shaft portion V12 and the first external electrode 21 can be achieved.

Assume a second imaginary plane S2 shown in FIG. 5 that passes through the boundary between the first end surface 10c and the rounded surface 10g and intersects the coil axis Ax perpendicularly. The second imaginary plane S2 extends parallel to the mounting surface 10b. The second imaginary plane S2 and the mounting surface 10b are spaced by a distance T3. In the illustrated embodiment, the dimension T2 of the first bottom-side shaft portion V12 in the T axis direction is larger than the distance T3 between the second imaginary plane S2 and the mounting surface 10b. Since the dimension T2 of the first bottom-side shaft portion V12 in the T axis direction is larger than the distance T3 between the second imaginary plane S2 and the mounting surface 10b, the volume of the margin region M1 can be larger, and this enhances the improvement of the magnetic characteristics and the DC superposition characteristics.

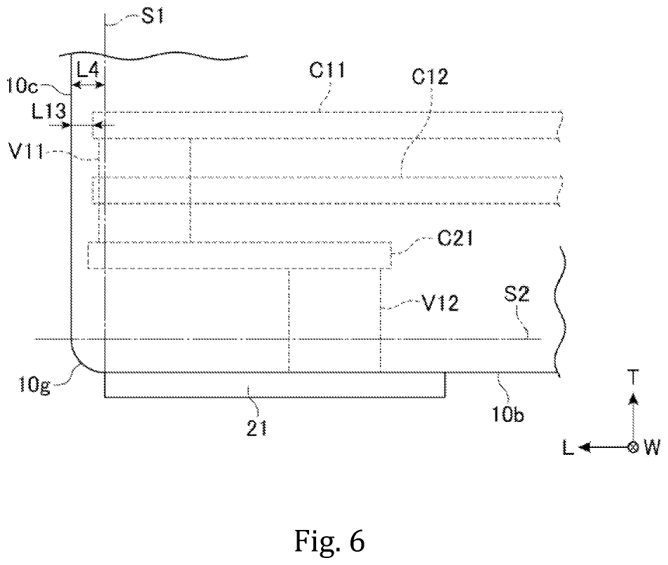

The shape and arrangement of the coil conductor 25 shown in FIGS. 1 to 5 are mere examples, and the coil conductor 25 applicable to the invention disclosed herein is not limited to the aspects described in FIGS. 1 to 5. Modifications of the coil conductor 25 will now be described with reference to FIGS. 6 to 8.

FIG. 6 shows one of the modifications of the coil conductor 25. In the embodiment shown in FIG. 6, the coil conductor 25 is configured and arranged such that the distance L13 between the winding portion 25a and the first end surface 10c is smaller than the distance L4 between the first imaginary plane S1 and the first end surface 10c. In the embodiment of FIG. 6, the distance L13 between the winding portion 25a and the first end surface 10c is smaller than the distance L4 between the first imaginary plane S1 and the first end surface 10c, and thus, the winding portion 25a can have a larger diameter. The larger diameter of the winding portion 25a further improves the magnetic characteristics of the coil component 1. Although not shown, when the mounting surface 10b and the second end surface 10d are connected by a rounded surface, the coil conductor 25 may be configured and arranged such that the distance between the winding portion 25a and the second end surface 10d is smaller than the distance between the second end surface 10d and an imaginary plane passing through the rounded surface between the mounting surface 10b and the second end surface 10d and extending parallel to the coil axis Ax.

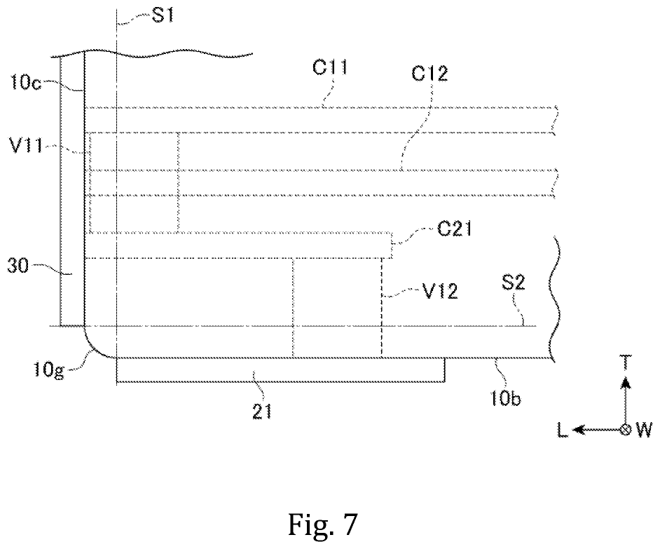

FIG. 7 shows another modification of the coil conductor 25. In the embodiment shown in FIG. 7, the coil conductor 25 is configured and arranged such that a portion of the winding portion 25a is exposed to the outside of the base body 10 through the first end surface 10c. On the first end surface 10c of the base body 10, there may be provided an insulating film 30 made of glass, resin, or other insulating material with an excellent insulation property. The insulating film 30 is provided on the first end surface 10c so as to cover the portion of the winding portion 25a that is exposed through the first end surface 10c. Although not shown, a portion of the winding portion 25a may be exposed to the outside of the base body 10 through the second end surface 10d as well as the first end surface 10c. When the winding portion 25a is exposed through the second end surface 10d, another insulating film 30 may be provided on the second end surface 10d so as to cover the portion of the winding portion 25a that is exposed through the second end surface 10d. In one embodiment, the first connection portion C21 may also be exposed through the first end surface 10c. When the first connection portion C21 is exposed through the first end surface 10c, the insulating film 30 provided on the first end surface 10c also covers the portion of the first connection portion C21 that is exposed through the first end surface 10c. In one embodiment, the second connection portion C22 may be exposed to the outside of the base body 10 through the second end surface 10d. When the second connection portion C22 is exposed through the second end surface 10d, the insulating film 30 provided on the second end surface 10d also covers the portion of the second connection portion C22 that is exposed through the second end surface 10d.

In the embodiment shown in FIG. 7, a portion of the winding portion 25a is exposed through the first end surface 10c and/or the second end surface 10d, and thus the winding portion 25a can have a further larger diameter. The larger diameter of the winding portion 25a further improves the magnetic characteristics of the coil component 1. In addition, since the portion of the winding portion 25a that is exposed through the first end surface 10c is covered by the insulating film 30, a short circuit can be prevented between the winding portion 25a and other conductive members.

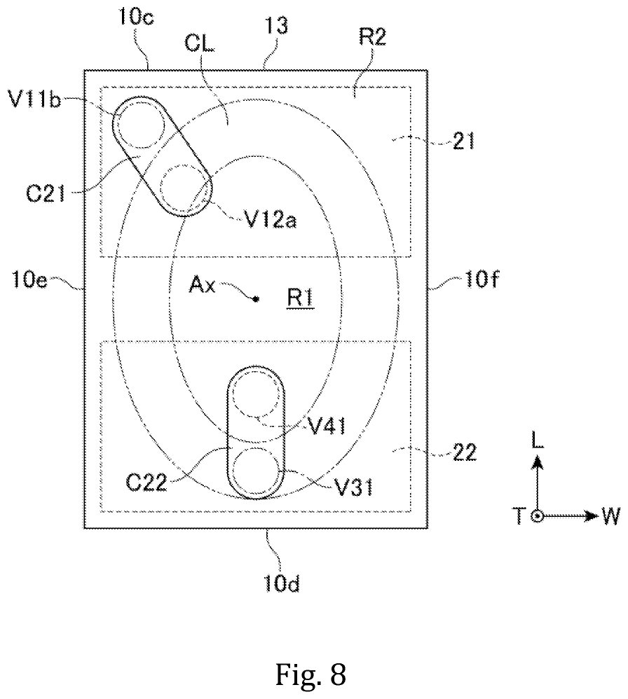

FIG. 8 shows a modification of the first connection portion C21. In the embodiment shown in FIG. 8, the via conductor V12a is not only located farther from the first end surface 10c, but also located farther from the first side surface 10e, compared to the via conductor V11b. In other words, the distance between the via conductor V12a and the first end surface 10c is larger than the distance between the via conductor V11b and the first end surface 10c, and the distance between the via conductor V12a and the first side surface 10e is larger than the distance between the via conductor V11b and the first side surface 10e. Although not shown, the via conductor V12b is embedded in a through hole formed in the magnetic film 14 at a position corresponding to the via conductor V12a and is connected to the via conductor V12a. In the embodiment shown in FIG. 8, a region having a larger volume than the region between the lead-out portion and the surface of the base body in conventional coil components can be provided in the base body 10 between the first bottom-side shaft portion V12 and the first side surface 10e as well as between the first bottom-side shaft portion V12 and the first end surface 10c. The coil component 1 can have better magnetic characteristics and DC superposition characteristics than conventional coil components in which the lead-out portion extends at a uniform and narrow interval from the surface of the base body.

The arrangement of the first top-side shaft portion V11 and the first bottom-side shaft portion V12 is not limited to the above aspects. The first bottom-side shaft portion V12 is configured and arranged such that the smaller of the distance between the first top-side shaft portion V11 and the first end surface 10c and the distance between the first top-side shaft portion V11 and the first side surface 10e is larger than the smaller of the distance between the first bottom-side shaft portion V12 and the first end surface and the distance between the first bottom-side shaft portion V12 and the first side surface 10e. Thus, a margin area for facilitating the passage of magnetic flux can be provided between the first bottom-side shaft portion V12 and at least one of the first end surface 10c and the first side surface 10e, such that the coil component 1 can have better magnetic characteristics and DC superposition characteristics than conventional coil components.

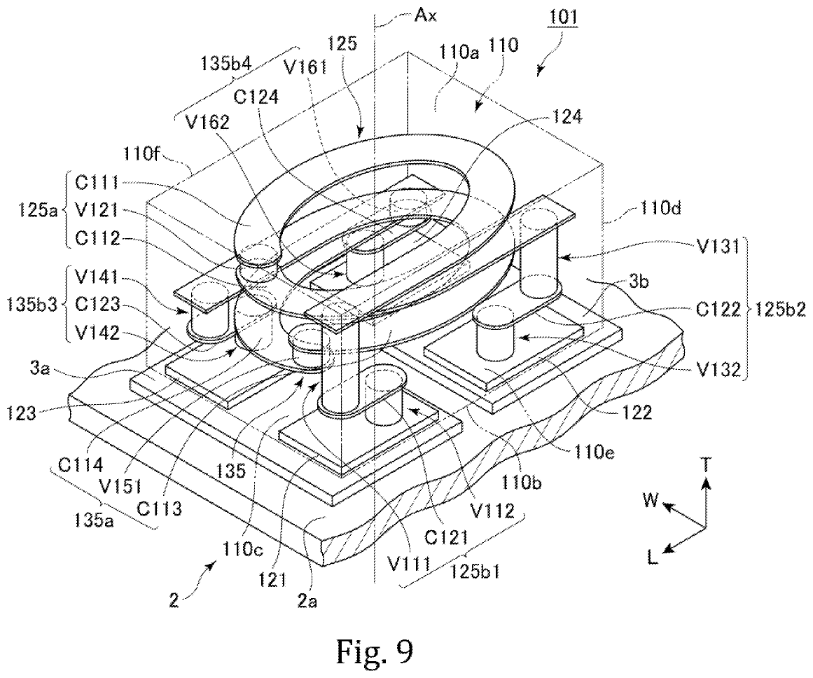

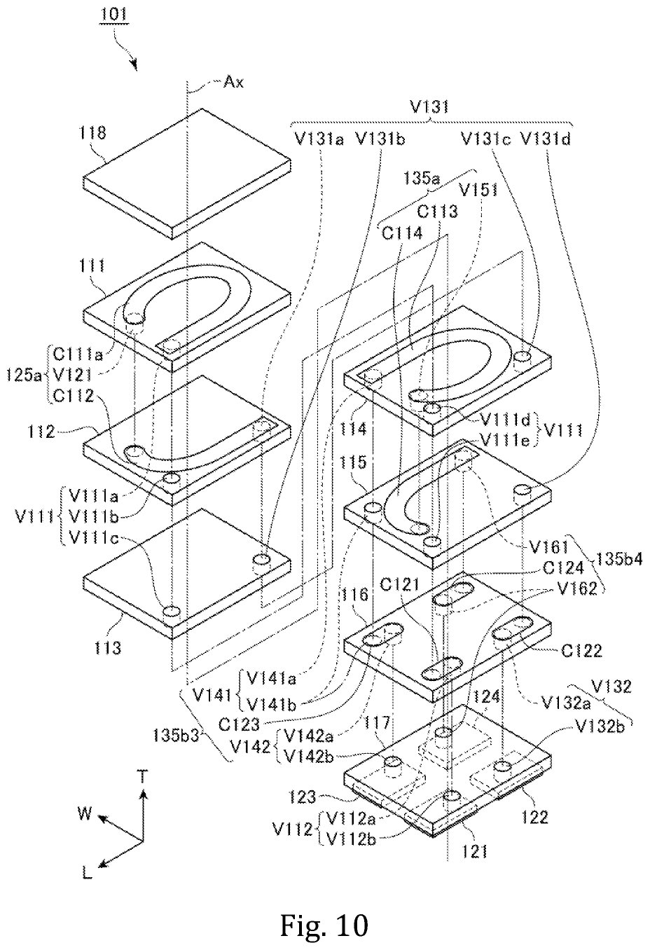

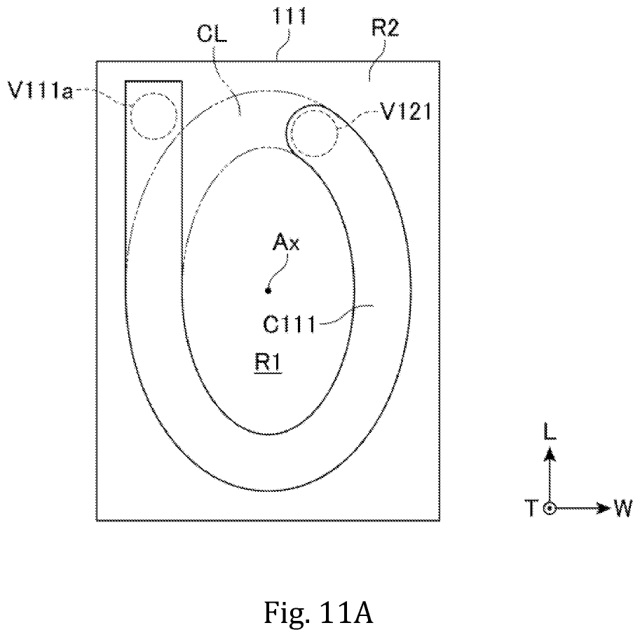

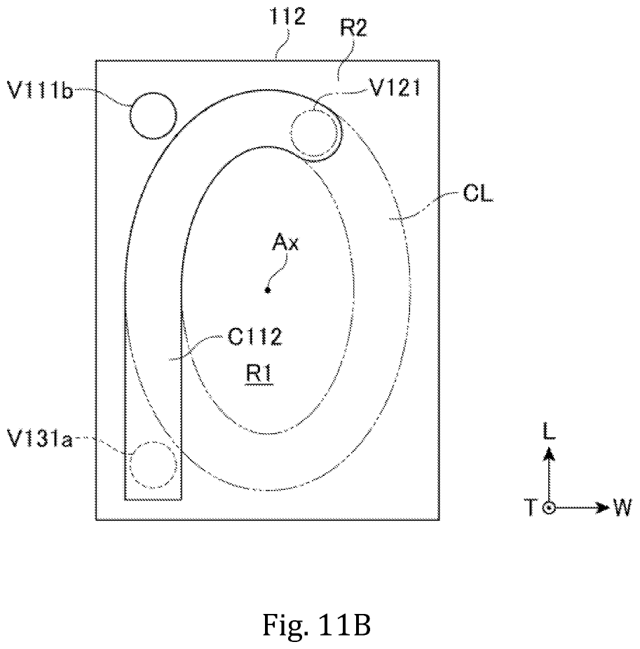

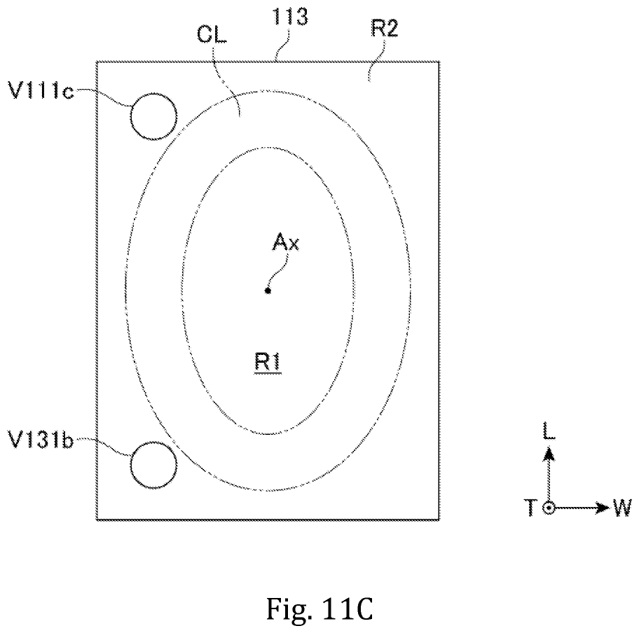

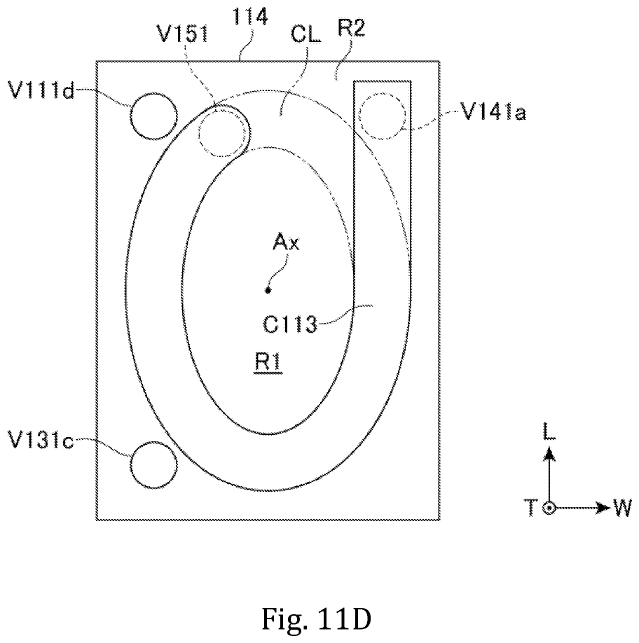

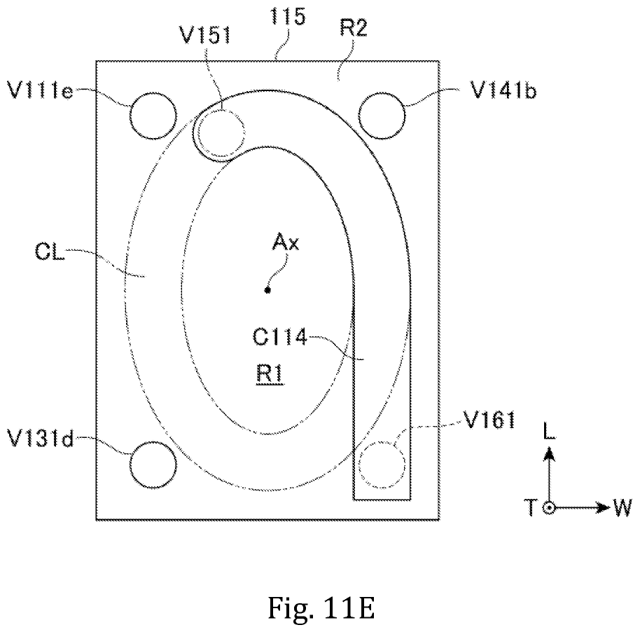

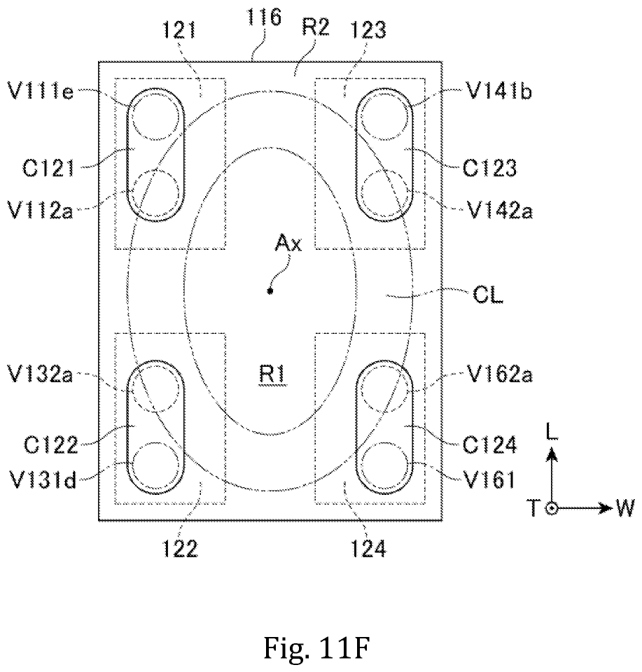

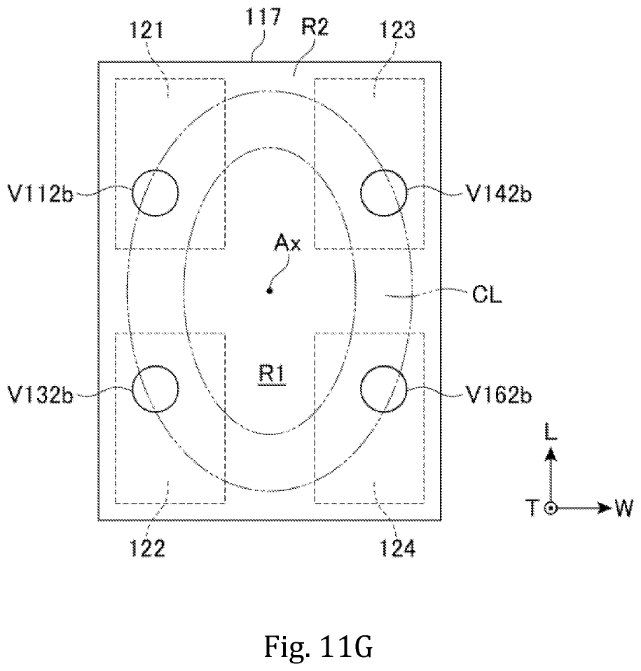

Next, a coil component 101 according to another embodiment will be described with reference to FIGS. 9, 10, and 11A to 11G. The elements of the coil component 101 that are the same as or similar to those of the coil component 1 will not be described. FIG. 9 is a schematic perspective view of the coil component 101, and FIG. 10 is an exploded perspective view of the coil component 101. FIGS. 11A to 11G show plan views of magnetic films 11 to 17, respectively.

The coil component 101 is a magnetically coupled coil component with two coil conductors. More specifically, the coil component 101 has a base body 110, a first coil conductor 125 provided in the base body 110, and a second coil conductor 135 provided in the base body 110 at a distance from the first coil conductor 125. The first coil conductor 125 and the second coil conductor 135 are electrically insulated from each other in the base body 10.

The base body 110 is formed of magnetic material, as is the base body 10. The outer surface of the base body 110 is defined by a top surface 110a, a mounting surface 110b, a first end surface 110c, a second end surface 110d, a first side surface 110e, and a second side surface 110f. The corners and/or edges of the base body 110 may be rounded.

On the mounting surface 110b of the base body 110, there are provided a first external electrode 121, a second external electrode 122, a third external electrode 123, and a fourth external electrode 124. The first external electrode 121, the second external electrode 122, the third external electrode 123, and the fourth external electrode 124 are spaced from each other.

The first coil conductor 125 includes a winding portion 125a, a first lead-out portion 125b1, and a second lead-out portion 125b2. The first lead-out portion 125b1 connects between one end of the winding portion 125a and the first external electrode 121. The second lead-out portion 125b2 connects between the other end of the winding portion 125a and the second external electrode 122. The second coil conductor 135 includes a winding portion 135a, a third lead-out portion 135b3, and a fourth lead-out portion 135b4. The third lead-out portion 135b3 connects between one end of the winding portion 135a and the third external electrode 123. The fourth lead-out portion 135b4 connects between the other end of the winding portion 135a and the fourth external electrode 124.

As shown in FIG. 10, the base body 110 includes magnetic films 111 to 118. The description on the magnetic films 11 to 15 of the coil component 1 also applies to the magnetic films 111 to 118 to a maximum extent.

In the embodiment shown, the base body 110 is a laminate formed of the magnetic films 111 to 118 stacked together. However, the boundaries between the magnetic films 111 to 118 may not be visible when a section of the base body 110 is observed under SEM. Of these magnetic films, the magnetic films 111, 112, 114, 115, and 116 have a conductor pattern formed on the top-side surface thereof. Specifically, the magnetic film 111 has a first conductor pattern C111 formed on the top-side surface thereof, the magnetic film 112 has a second conductor pattern C112 formed on the top-side surface thereof, the magnetic film 114 has a third conductor pattern C113 formed on the top-side surface thereof, and the magnetic film 115 has a fourth conductor pattern C114 formed on the top-side surface thereof. Each of the first conductor pattern C111 to the fourth conductor pattern C114 extends in the circumferential direction around a coil axis Ax that extends along the T axis direction. The magnetic film 116 has a first connection portion C121, a second connection portion C122, a third connection portion C123, and a fourth connection portion C124 formed on the top-side surface thereof. The connection portions C121 to C124 are conductor patterns for connecting between via conductors. Each of the magnetic films 111 to 117 has through holes formed at predetermined positions to extend through the magnetic film in the T axis direction, and the via conductors are embedded in these through holes. The conductor patters and the via conductors of the coil component 101 are formed as follows: for example, a conductive paste formed of a metal or an alloy having an excellent conductivity is printed by screen printing on magnetic sheets that are precursor of the magnetic films 111 to 117, and the conductive paste printed on the magnetic sheets is heated.

With further reference to FIGS. 11A to 11G, a further description is given of the conductor patterns and the via conductors of the coil component 101. As shown in FIG. 11A, the first conductor pattern C111 is formed on the top-side surface of the magnetic film 111. In the embodiment shown, the first conductor pattern C111 has the same shape as the first conductor pattern C11. The description on the first conductor pattern C11 also applies to the first conductor pattern C111 to a maximum extent. The magnetic film 111 has a through hole extending therethrough in the T axis direction at the region overlapping with one end of the first conductor pattern C111, and a via conductor Villa is embedded in this through hole. The magnetic film 111 also has a through hole extending therethrough in the T axis direction at the region overlapping with the other end of the first conductor pattern C111, and a via conductor V121 is embedded in this through hole.

As shown in FIG. 11B, the second conductor pattern C112 is formed on the top-side surface of the magnetic film 112. The second conductor pattern C112 extends in the circumferential direction around the coil axis Ax within a plane orthogonal to the coil axis Ax (the LW plane) for less than one turn. In the embodiment shown, the second conductor pattern C112 extends in the circumferential direction around the coil axis Ax for turns. One end of the second conductor pattern C112 is connected to the via conductor V121. The magnetic film 112 has a through hole extending therethrough in the T axis direction at the region overlapping with the other end of the second conductor pattern C112, and a via conductor V131a is embedded in this through hole. The other end of the second conductor pattern C112 is connected to the via conductor V131a.

The magnetic film 112 has a through hole extending therethrough in the T axis direction at the region overlapping with the via conductor Villa in plan view, and a via conductor V111b is embedded in this through hole. The via conductor V111b is connected to the via conductor Villa.

As shown in FIG. 11C, the magnetic film 113 has a through hole extending therethrough in the T axis direction at the region overlapping with the via conductor V111b in plan view, and a via conductor V111c is embedded in this through hole. The via conductor V111c is connected to the via conductor V111b. The magnetic film 113 has a through hole extending therethrough in the T axis direction at the region overlapping with the via conductor V131a in plan view, and a via conductor V131b is embedded in this through hole. The via conductor V131b is connected to the via conductor V131a.

As shown in FIG. 11D, the third conductor pattern C113 is formed on the top-side surface of the magnetic film 114. In the embodiment shown, the third conductor pattern C113 has a shape that is line symmetrical with that of the first conductor pattern C111 with respect to an axis of symmetry that intersects the coil axis Ax and extends along the L axis. The magnetic film 114 has a through hole extending therethrough in the T axis direction at the region overlapping with one end of the third conductor pattern C113, and a via conductor V141a is embedded in this through hole. The magnetic film 114 also has a through hole extending therethrough in the T axis direction at the region overlapping with the other end of the third conductor pattern C113, and a via conductor V151 is embedded in this through hole.

The magnetic film 114 has a through hole extending therethrough in the T axis direction at the region overlapping with the via conductor V111c in plan view, and a via conductor V111d is embedded in this through hole. The via conductor V111d is connected to the via conductor V111c. The magnetic film 114 has a through hole extending therethrough in the T axis direction at the region overlapping with the via conductor V131b in plan view, and a via conductor V131c is embedded in this through hole. The via conductor V131c is connected to the via conductor V131b.

As shown in FIG. 11E, the fourth conductor pattern C114 is formed on the top-side surface of the magnetic film 115. In the embodiment shown, the fourth conductor pattern C114 has a shape that is line symmetrical with that of the second conductor pattern C112 with respect to an axis of symmetry that intersects the coil axis Ax and extends along the L axis. One end of the fourth conductor pattern C114 is connected to the via conductor V151. The magnetic film 115 has a through hole extending therethrough in the T axis direction at the region overlapping with the other end of the fourth conductor pattern C114, and a via conductor V161 is embedded in this through hole. The other end of the fourth conductor pattern C114 is connected to the via conductor V161.

The magnetic film 115 has a through hole extending therethrough in the T axis direction at the region overlapping with the via conductor V111d in plan view, and a via conductor Ville is embedded in this through hole. The via conductor Ville is connected to the via conductor V111d. The magnetic film 115 has a through hole extending therethrough in the T axis direction at the region overlapping with the via conductor V131c in plan view, and a via conductor V131d is embedded in this through hole. The via conductor V131d is connected to the via conductor V131c. The magnetic film 115 has a through hole extending therethrough in the T axis direction at the region overlapping with the via conductor V141a in plan view, and a via conductor V141b is embedded in this through hole. The via conductor V141b is connected to the via conductor V141a.

As shown in FIG. 11F, a first connection portion C121, a second connection portion C122, a third connection portion C123, and a fourth connection portion C124 are formed on the top-side surface of the magnetic film 116. One end of the first connection portion C121 is connected to the via conductor Ville. The magnetic film 116 has a through hole extending therethrough in the T axis direction at the region overlapping with the other end of the first connection portion C121, and a via conductor V112a is embedded in this through hole. The other end of the first connection portion C121 is connected to the via conductor V112a. Thus, on the top-side surface of the magnetic film 116, the first connection portion C121 extends from one end thereof connected to the via conductor Ville to the other end thereof connected to the via conductor V112a.

One end of the second connection portion C122 is connected to the via conductor V131d. The magnetic film 116 has a through hole extending therethrough in the T axis direction at the region overlapping with the other end of the second connection portion C122, and a via conductor V132a is embedded in this through hole. The other end of the second connection portion C122 is connected to the via conductor V132a. Thus, on the top-side surface of the magnetic film 116, the second connection portion C122 extends from one end thereof connected to the via conductor V131d to the other end thereof connected to the via conductor V132a.

One end of the third connection portion C123 is connected to the via conductor V141b. The magnetic film 116 has a through hole extending therethrough in the T axis direction at the region overlapping with the other end of the third connection portion C123, and a via conductor V142a is embedded in this through hole. The other end of the third connection portion C123 is connected to the via conductor V142a. Thus, on the top-side surface of the magnetic film 116, the third connection portion C123 extends from one end thereof connected to the via conductor V141b to the other end thereof connected to the via conductor V142a.

One end of the fourth connection portion C124 is connected to the via conductor V161. The magnetic film 116 has a through hole extending therethrough in the T axis direction at the region overlapping with the other end of the fourth connection portion C124, and a via conductor V162a is embedded in this through hole. The other end of the fourth connection portion C124 is connected to the via conductor V162a. Thus, on the top-side surface of the magnetic film 116, the fourth connection portion C124 extends from one end thereof connected to the via conductor V161 to the other end thereof connected to the via conductor V162a.

At least one of the first to fourth connection portions C121 to C124 may extend straight along the LW plane. The straight shape of the first to fourth connection portions C121 to C124 can inhibit the increase of DC resistance Rdc due to the first to fourth connection portions C121 to C124 having the straight shape. In the embodiment shown, each of the first to fourth connection portions C121 to C124 extends straight along the L axis direction. Each of the first to fourth connection portions C121 to C124 may extend in a direction oblique to the L axis, as the first connection portion C21 shown in FIG. 8.

As shown in FIG. 11G, the magnetic film 117 has through holes extending therethrough in the T axis direction at the region overlapping with the via conductor V112a, the region overlapping with the via conductor V132a, the region overlapping with the via conductor V142a, the region overlapping with the via conductor V162a in plan view. A via conductor V112b is embedded in the through hole formed in the region overlapping with the via conductor V112a, and a via conductor V132b is embedded in the through hole formed in the region overlapping with the via conductor V132a. The top-side end of the via conductor V112b is connected to the bottom-side end of the via conductor V112a, and the bottom-side end of the via conductor V112b is connected to the first external electrode 121. The top-side end of the via conductor V132b is connected to the bottom-side end of the via conductor V132a, and the bottom-side end of the via conductor V132b is connected to the second external electrode 122. A via conductor V142b is embedded in the through hole formed in the region overlapping with the via conductor V142a, and a via conductor V162b is embedded in the through hole formed in the region overlapping with the via conductor V162a. The top-side end of the via conductor V142b is connected to the bottom-side end of the via conductor V142a, and the bottom-side end of the via conductor V142b is connected to the third external electrode 123. The top-side end of the via conductor V162b is connected to the bottom-side end of the via conductor V162a, and the bottom-side end of the via conductor V162b is connected to the fourth external electrode 124.

As described above, the first conductor pattern C111 and the second conductor pattern C112 are connected by the via conductor V121. The first conductor pattern C111, the via conductor V121, and the second conductor pattern C112 connected in this manner constitute a winding portion 125a having a spiral shape and extending for 1.25 turns around the coil axis Ax in the base body 10. Also, the third conductor pattern C113 and the fourth conductor pattern C114 are connected by the via conductor V151. The third conductor pattern C113, the via conductor V151, and the fourth conductor pattern C114 connected in this manner constitute a winding portion 135a having a spiral shape and extending for 1.25 turns around the coil axis Ax in the base body 10.

One end of the winding portion 125a (one end of the first conductor pattern C111) is connected to the first external electrode 121 via the via conductors Villa to Ville, the first connection portion C121, the via conductor V112a, and the via conductor V112b. The via conductors Villa to Ville are located on the same axis extending parallel to the T axis, and thus these via conductors are collectively referred to as the first top-side shaft portion V111. The first top-side shaft portion V111 is constituted by the via conductors Villa to Ville. The via conductors V112a and V112b are located on the same axis extending parallel to the T-axis and are positioned lower (closer to the mounting surface 110b) than the first top-side shaft portion V111, and thus these via conductors are collectively referred to as the first bottom-side shaft portion V112. The first bottom-side shaft portion V112 is constituted by the via conductor V112a and the via conductor V112b. As described above, one end of the winding portion 125a is connected to the first external electrode 121 via the first lead-out portion 125b1, which is constituted by the first top-side shaft portion V111, the first connection portion C121, and the first bottom-side shaft portion V112.

The other end of the winding portion 125a (one end of the second conductor pattern C112) is connected to the second external electrode 122 via the via conductors V131a to V131d, the second connection portion C122, the via conductor V132a, and the via conductor V132b. The via conductors V131a to V131d are located on the same axis extending parallel to the T axis, and thus these via conductors are collectively referred to as the second top-side shaft portion V131. The second top-side shaft portion V131 is constituted by the via conductors V131a to V131d. The via conductors V132a and V132b are located on the same axis extending parallel to the T-axis and are positioned lower (closer to the mounting surface 110b) than the second top-side shaft portion V131, and thus these via conductors are collectively referred to as the second bottom-side shaft portion V132. The second bottom-side shaft portion V132 is constituted by the via conductor V132a and the via conductor V132b. As described above, the other end of the winding portion 125a is connected to the second external electrode 122 via the second lead-out portion 125b2, which is constituted by the second top-side shaft portion V131, the second connection portion C122, and the second bottom-side shaft portion V132.

One end of the winding portion 135a (one end of the third conductor pattern C113) is connected to the third external electrode 123 via the via conductor V141a, the via conductor V141b, the third connection portion C123, the via conductor V142a, and the via conductor V142b. The via conductors V141a and V141b are located on the same axis extending parallel to the T axis, and thus these via conductors are collectively referred to as the third top-side shaft portion V141. The third top-side shaft portion V141 is constituted by the via conductor V141a and the via conductor V141b. The via conductors V142a and V142b are located on the same axis extending parallel to the T-axis and are positioned lower (closer to the mounting surface 110b) than the third top-side shaft portion V141, and thus these via conductors are collectively referred to as the third bottom-side shaft portion V142. The third bottom-side shaft portion V142 is constituted by the via conductor V142a and the via conductor V142b. As described above, one end of the winding portion 135a is connected to the third external electrode 123 via the third lead-out portion 135b3, which is constituted by the third top-side shaft portion V141, the third connection portion C123, and the third bottom-side shaft portion V142.

The other end of the winding portion 135a (one end of the fourth conductor pattern C114) is connected to the fourth external electrode 124 via the via conductor V161, the fourth connection portion C124, the via conductor V162a, and the via conductor V162b. The via conductors V162a and V162b are located on the same axis extending parallel to the T axis and are positioned lower (closer to the mounting surface 110b) than the via conductor V161, and thus these via conductors are collectively referred to as the fourth bottom-side shaft portion V162. The fourth bottom-side shaft portion V162 is constituted by the via conductor V162a and the via conductor V162b. The via conductor V161, which is located higher than the fourth bottom-side shaft portion V162 and extends in the T axis direction, may be herein referred to as the fourth top-side shaft portion V161. As described above, the other end of the winding portion 135a is connected to the fourth external electrode 124 via the fourth lead-out portion 135b4, which is constituted by the fourth top-side shaft portion V161, the fourth connection portion C124, and the fourth bottom-side shaft portion V162.

For example, the number of turns of the winding portions 125a and 135a ranges from 1.1 to 2.5. When the number of turns of the winding portion 125a is 3 or less, the lengths of the first lead-out portion 125b1 and the second lead-out portion 125b2 account for a large proportion of the entire length of the first coil conductor 125, and thus the shape and arrangement of the first lead-out portion 125b1 and the second lead-out portion 125b2 have a large effect on the characteristics of the coil component 101. Likewise, when the number of turns of the winding portion 135a is 3 or less, the lengths of the third lead-out portion 135b3 and the fourth lead-out portion 135b4 account for a large proportion of the entire length of the second coil conductor 135, and thus the shape and arrangement of the third lead-out portion 135b3 and the fourth lead-out portion 135b4 have a large effect on the characteristics of the coil component 101. As described for coil component 1, in the coil component 101, the first lead-out portion 125b1 includes the first bottom-side shaft portion V112 located closer to the coil axis Ax than the first top-side shaft portion V111, and the third lead-out portion 135b3 includes the third bottom-side shaft portion V142 located closer to the coil axis Ax than the third top-side shaft portion V141. Thus, a margin region having a larger volume than the region between the lead-out portion and the surface of the base body in conventional coil components is present between the first bottom-side shaft portion V112 and the first end surface 110c and between the third bottom-side shaft portion V142 and the first end surface 110c in the base body 110. Therefore, the magnetic flux generated by the change in electric current flowing through the first lead-out portion 125b1 and the third lead-out portion 135b3 can pass through the large margin region present between the first end surface 110c and these lead-out portions. Likewise, the second lead-out portion 125b2 includes the second bottom-side shaft portion V132 located closer to the coil axis Ax than the second top-side shaft portion V131, and the fourth lead-out portion 135b4 includes the fourth bottom-side shaft portion V162 located closer to the coil axis Ax than the fourth top-side shaft portion V161. Thus, a margin region having a larger volume than the region between the lead-out portion and the surface of the base body in conventional coil components is present between the second bottom-side shaft portion V132 and the second end surface 110d and between the fourth bottom-side shaft portion V162 and the second end surface 110d in the base body 110. Therefore, the magnetic flux generated by the change in electric current flowing through the second lead-out portion 125b2 and the fourth lead-out portion 135b4 can pass through the large margin region present between the second end surface 110d and these lead-out portions. Therefore, as with the coil component 1, the coil component 101 can have better magnetic characteristics and DC superposition characteristics than conventional coil components in which the lead-out portion extends at a uniform and narrow interval from the surface of the base body.

Next, a description is given of an example of a method of manufacturing the coil component 1. The coil component 1 can be manufactured by, for example, a lamination process. An example is hereinafter described of the manufacturing method of the coil component 1 by the sheet lamination.

To begin with, magnetic sheets are fabricated as precursors of the magnetic films constituting the base body 10 (the magnetic films 1 to 15). The magnetic sheets are fabricated as follows. For example, soft magnetic metal particles are mixed and kneaded with a resin to prepare a slurry. The slurry is then applied to a surface of a plastic base film using the doctor blade technique or any other common methods and dried, and the dried slurry is cut to a predetermined size.

Next, a through hole is formed in each of the magnetic sheets as the precursors of the magnetic films 11 to 14 at a predetermined position so as to extend through the magnetic sheets in the T axis direction. Following this, a conductive paste is printed by screen printing on the top surface of each of the magnetic sheets to be the magnetic films 11 to 14, so that an unfired conductor pattern is formed on each of the magnetic sheets. The through holes formed in the magnetic sheets are filled with the conductive paste. In this way, the unfired conductor pattern formed on the magnetic sheet as the precursor of the magnetic film 11 forms the first conductor pattern C11 after heating, and the unfired conductor pattern formed on the magnetic sheet as the precursor of the magnetic film 12 forms the second conductor pattern C12 after heating. The unfired conductor pattern formed on the magnetic sheet as the precursor of the magnetic film 13 forms the first connection portion C21 after heating. The conductor patterns can also be formed by any various known methods other than the screen printing.

The magnetic sheet as the precursor of the magnetic film 11 may be a single magnetic sheet or a laminated sheet constituted by multiple magnetic sheets stacked together. Likewise, each of the magnetic sheets as the precursors of the magnetic films 12 to 15 may be a single magnetic sheet or a laminated sheet constituted by multiple magnetic sheets stacked together. The thickness of each of the magnetic films 11 to 15 can be adjusted by adjusting the number of magnetic sheets that make up the magnetic films 11 to 15. To increase the volume of the margin region M1 by increasing the dimension of the first bottom-side shaft portion V12 in the T axis direction, the number of magnetic sheets constituting the magnetic film 14 can be larger than the number of magnetic sheets constituting the magnetic film 11 or 12. Since the magnetic film 15 serves as a cover layer over the top surface of the coil conductor 25, it may be constituted by multiple magnetic sheets to obtain the thickness necessary for the cover layer.

Next, the magnetic sheets as the precursors of the magnetic films 11 to 15 are stacked together to obtain a laminate. The magnetic sheets stacked together may be bonded together by thermal compression using a pressing machine to obtain a laminate. Then, the laminate is diced to a desired size by using a cutter such as a dicing machine or a laser processing machine to make a chip laminate. Polishing treatment such as barrel polishing may be performed on the end portions of the chip laminate, if necessary.

Next, the chip laminate is degreased and then subjected to thermal treatment, so that the base body 10 is obtained. The thermal treatment forms an oxide layer on the surface of each soft magnetic metal particle contained in the magnetic sheets, so that the adjacent soft magnetic metal particles are bonded to each other via the oxide layers. The thermal treatment is performed on the chip laminate at a temperature of 600° C. to 800° C. for a duration of 20 to 120 minutes.

Following this, a conductive paste is applied to the mounting surface 10b of the base body 10 to form the first and second external electrodes 21 and 22. A plated layer may also be included. The plated layer may include two or more layers. The two-layered plated layer may include a Ni plated layer and a Sn plated layer disposed on an outer side of the Ni plated layer. By the above-described process, the coil component 1 can be obtained.

It is also possible to produce the coil component 1 by the compression molding, thin film processing, slurry build or any other known methods.

The coil component 101 can also be manufactured in accordance with the manufacturing method of the coil component 1.

A part of the steps included in the above manufacturing method may be skipped as necessary. In the manufacturing method of the coil component 1, steps not described explicitly in this specification may be performed as necessary. A part of the steps included in the manufacturing method of the coil component 1 may be performed in different order within the purport of the present invention. A part of the steps included in the manufacturing method of the coil component 1 may be performed at the same time or in parallel, if possible.

The dimensions, materials, and arrangements of the constituent elements described for the above various embodiments are not limited to those explicitly described for the embodiments, and these constituent elements can be modified to have any dimensions, materials, and arrangements within the scope of the present invention. For example, in the embodiments shown in FIGS. 1 to 5, the first bottom-side shaft portion V12 is positioned closer to the coil axis Ax than the first top-side shaft portion V11, and the second bottom-side shaft portion V32 is positioned closer to the coil axis Ax than the second top-side shaft portion V31, but it is also possible that only one of the first bottom-side shaft portion V12 and the second bottom-side shaft portion V32 is positioned closer to the coil axis Ax than the corresponding one of the first top-side shaft portion V11 and the second top-side shaft portion V31. This arrangement also allows presence of a large region to be passed by the magnetic flux around at least one of the first lead-out portion 25b1 or the second lead-out portion 25b2, such that the coil component 1 can have better magnetic characteristics and DC superposition characteristics.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

Embodiments disclosed herein also include the following.

### Additional Embodiment 1

A coil component comprising:
a base body made of a magnetic material and having a mounting surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion located closer to the coil axis than the first top-side shaft portion and extending from the first external electrode along the coil axis, and a first connection portion connecting between the first top-side shaft portion and the first bottom-side shaft portion.

### Additional Embodiment 2

The coil component of Additional Embodiment 1,
wherein as viewed from a direction of the coil axis, a portion of the winding portion extends for one or more turns in a circumferential direction around the coil axis along a closed loop path, and
wherein as viewed from the direction of the coil axis, the first top-side shaft portion is positioned so as not to overlap with the closed loop path, and the first bottom-side shaft portion is positioned so as to overlap with the closed loop path.

### Additional Embodiment 3

The coil component of Additional Embodiment 1 or 2,
wherein a dimension of the first bottom-side shaft portion in a direction along the coil axis is larger than a dimension of the first top-side shaft portion in the direction along the coil axis.

### Additional Embodiment 4

The coil component of any one of Additional Embodiments 1 to 3,
wherein the base body has a first end surface extending along the coil axis, and the base body has a rounded surface connecting between the first end surface and the mounting surface, and
wherein a distance between the winding portion and the first end surface is smaller than a distance between the first end surface and a first imaginary plane passing through a boundary between the mounting surface and the rounded surface and extending parallel to the coil axis.

### Additional Embodiment 5

The coil component of any one of Additional Embodiments 1 to 4,
wherein a portion of the winding portion is exposed to an outside of the base body through the first end surface.

### Additional Embodiment 6

The coil component of Additional Embodiment 5,
wherein the portion of the winding portion that is exposed through the first end surface is covered by an insulating film.

### Additional Embodiment 7

The coil component of any one of Additional Embodiments 1 to 6,
wherein the base body has a first end surface extending along the coil axis, and the base body has a rounded surface connecting between the first end surface and the mounting surface, and
wherein a distance between the winding portion and the first end surface is equal to or larger than a distance between the first end surface and a first imaginary plane passing through a boundary between the mounting surface and the rounded surface and extending parallel to the coil axis.

### Additional Embodiment 8

The coil component of any one of Additional Embodiments 1 to 7,
wherein the second lead-out portion includes a second top-side shaft portion extending from one end of the winding portion along the coil axis, a second bottom-side shaft portion located closer to the coil axis than the second top-side shaft portion as viewed from a direction of the coil axis and extending from the second external electrode along the coil axis, and a second connection portion connecting between the second top-side shaft portion and the second bottom-side shaft portion.

### Additional Embodiment 9

The coil component of any one of Additional Embodiments 1 to 8,
another coil conductor different from the coil conductor;
a third external electrode provided on the mounting surface, the third external electrode being spaced apart from the first external electrode and the second external electrode; and
a fourth external electrode provided on the mounting surface, the fourth external electrode being spaced apart from the first external electrode, the second external electrode, and the third external electrode,
wherein the other coil conductor includes another winding portion provided in the base body and extending in a circumferential direction around the coil axis, a third lead-out portion connecting between one end of the other winding portion and the third external electrode, and a fourth lead-out portion connecting between another end of the other winding portion and the fourth external electrode, and
wherein the third lead-out portion includes a third top-side shaft portion extending from one end of the other winding portion along the coil axis, a third bottom-side shaft portion located closer to the coil axis than the third top-side shaft portion as viewed from a direction of the coil axis and extending from the third external electrode along the coil axis, and a third connection portion connecting between the third top-side shaft portion and the third bottom-side shaft portion.

### Additional Embodiment 10

The coil component of any one of Additional Embodiments 1 to 9,
wherein a volume of the base body is smaller than 1.5 mm³.

### Additional Embodiment 11

The coil component of any one of Additional Embodiments 1 to 10, wherein a number of turns of the winding portion in a circumferential direction around the coil axis is 3 or less.

### Additional Embodiment 12

A coil component comprising:
a base body made of a magnetic material and having a mounting surface, a first end surface connected to the mounting surface, and a first side surface connected to the mounting surface and the first end surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion extending along the coil axis, and a first connection portion connecting between the first top-side shaft portion and the first bottom-side shaft portion, and
wherein the first bottom-side shaft portion is positioned such that a distance between the first bottom-side shaft portion and the first end surface is larger than a distance between the first top-side shaft portion and the first end surface, and a distance between the first bottom-side shaft portion and the first side surface is equal to or larger than a distance between the first top-side shaft portion and the first side surface.

### Additional Embodiment 13

The coil component of Additional Embodiment 12, wherein a number of turns of the winding portion in a circumferential direction around the coil axis is 3 or less.

### Additional Embodiment 14

A coil component comprising:
a base body made of a magnetic material and having a mounting surface, a first end surface connected to the mounting surface, and a first side surface connected to the mounting surface and the first end surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion extending along the coil axis, and a first connection portion connecting between the first top-side shaft portion and the first bottom-side shaft portion, and
wherein the first bottom-side shaft portion is positioned such that a distance between the first bottom-side shaft portion and the first end surface is equal to or larger than a distance between the first top-side shaft portion and the first end surface, and a distance between the first bottom-side shaft portion and the first side surface is larger than a distance between the first top-side shaft portion and the first side surface.

### Additional Embodiment 15

The coil component of Additional Embodiment 14, wherein a number of turns of the winding portion in a circumferential direction around the coil axis is 3 or less.

### Additional Embodiment 16

A circuit board comprising the coil component of any one of Additional Embodiments 1 to 15.

### Additional Embodiment 17

An electronic component comprising the circuit board of Additional Embodiment 16.

What is claimed is:

1. A coil component comprising:
a base body made of a magnetic material and having a mounting surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion located closer to the coil axis than the first top-side shaft portion and extending from the first external electrode along the coil axis, and a first connection portion connecting between the first top-side shaft portion and the first bottom-side shaft portion.

2. The coil component of claim 1,
wherein as viewed from a direction of the coil axis, a portion of the winding portion extends for one or more turns in a circumferential direction around the coil axis along a closed loop path, and
wherein as viewed from the direction of the coil axis, the first top-side shaft portion is positioned so as not to overlap with the closed loop path, and the first bottom-side shaft portion is positioned so as to overlap with the closed loop path.

3. The coil component of claim 1, wherein a dimension of the first bottom-side shaft portion in a direction along the coil axis is larger than a dimension of the first top-side shaft portion in the direction along the coil axis.

4. The coil component of claim 1,
wherein the base body has a first end surface extending along the coil axis, and the base body has a rounded surface connecting between the first end surface and the mounting surface, and
wherein a distance between the winding portion and the first end surface is smaller than a distance between the first end surface and a first imaginary plane passing through a boundary between the mounting surface and the rounded surface and extending parallel to the coil axis.

5. The coil component of claim 1, wherein a portion of the winding portion is exposed to an outside of the base body through the first end surface.

6. The coil component of claim 5, wherein the portion of the winding portion that is exposed through the first end surface is covered by an insulating film.

7. The coil component of claim 1,
wherein the base body has a first end surface extending along the coil axis, and the base body has a rounded surface connecting between the first end surface and the mounting surface, and
wherein a distance between the winding portion and the first end surface is equal to or larger than a distance between the first end surface and a first imaginary plane passing through a boundary between the mounting surface and the rounded surface and extending parallel to the coil axis.

8. The coil component of claim 1,
wherein the second lead-out portion includes a second top-side shaft portion extending from one end of the winding portion along the coil axis, a second bottom-side shaft portion located closer to the coil axis than the second top-side shaft portion as viewed from a direction of the coil axis and extending from the second external electrode along the coil axis, and a second connection portion connecting between the second top-side shaft portion and the second bottom-side shaft portion.

9. The coil component of claim 1, further comprising:
another coil conductor different from the coil conductor;
a third external electrode provided on the mounting surface, the third external electrode being spaced apart from the first external electrode and the second external electrode; and
a fourth external electrode provided on the mounting surface, the fourth external electrode being spaced apart from the first external electrode, the second external electrode, and the third external electrode,
wherein the other coil conductor includes another winding portion provided in the base body and extending in a circumferential direction around the coil axis, a third lead-out portion connecting between one end of the other winding portion and the third external electrode, and a fourth lead-out portion connecting between another end of the other winding portion and the fourth external electrode, and
wherein the third lead-out portion includes a third top-side shaft portion extending from one end of the other winding portion along the coil axis, a third bottom-side shaft portion located closer to the coil axis than the third top-side shaft portion as viewed from a direction of the coil axis and extending from the third external electrode along the coil axis, and a third connection portion connecting between the third top-side shaft portion and the third bottom-side shaft portion.

10. The coil component of claim 1, wherein a volume of the base body is smaller than 1.5 mm³.

11. The coil component of claim 1, wherein a number of turns of the winding portion in a circumferential direction around the coil axis is 3 or less.

12. A coil component comprising:
a base body made of a magnetic material and having a mounting surface, a first end surface connected to the mounting surface, and a first side surface connected to the mounting surface and the first end surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion extending along the coil axis, and a first connection portion connecting between the first top-side shaft portion and the first bottom-side shaft portion, and
wherein the first bottom-side shaft portion is positioned such that a distance between the first bottom-side shaft portion and the first end surface is larger than a distance between the first top-side shaft portion and the first end surface, and a distance between the first bottom-side shaft portion and the first side surface is equal to or larger than a distance between the first top-side shaft portion and the first side surface.

13. The coil component of claim 12, wherein a number of turns of the winding portion in a circumferential direction around the coil axis is 3 or less.

14. A coil component comprising:
a base body made of a magnetic material and having a mounting surface, a first end surface connected to the mounting surface, and a first side surface connected to the mounting surface and the first end surface;
a first external electrode provided on the mounting surface;
a second external electrode provided on the mounting surface, the second external electrode being spaced apart from the first external electrode; and
a coil conductor including a winding portion provided in the base body and extending in a circumferential direction around a coil axis, a first lead-out portion connecting between one end of the winding portion and the first external electrode, and a second lead-out portion connecting between another end of the winding portion and the second external electrode,
wherein the first lead-out portion includes a first top-side shaft portion extending from one end of the winding portion along the coil axis, a first bottom-side shaft portion extending along the coil axis, and a first connection portion connecting between the first top-side shaft portion and the first bottom-side shaft portion, and
wherein the first bottom-side shaft portion is positioned such that a distance between the first bottom-side shaft portion and the first end surface is equal to or larger than a distance between the first top-side shaft portion and the first end surface, and a distance between the first bottom-side shaft portion and the first side surface is larger than a distance between the first top-side shaft portion and the first side surface.

15. The coil component of claim 14, wherein a number of turns of the winding portion in a circumferential direction around the coil axis is 3 or less.

16. A circuit board comprising the coil component of claim 1.

17. An electronic component comprising the circuit board of claim 16.
